(19) United States
(12) Patent Application Publication
(10) Pub. No.: US 2026/0196433 A1
(43) Pub. Date: Jul. 9, 2026

(54) RELAY

(71) Applicant: Xiamen Hongfa Electric Power Controls Co., Ltd., Xiamen, Fujian (CN)

(72) Inventors: Zhongbo HE, Xiamen, Fujian (CN); Wenguang DAI, Xiamen, Fujian (CN); Shuming ZHONG, Xiamen, Fujian (CN); Feng HE, Xiamen, Fujian (CN)

(21) Appl. No.: 19/134,660

(22) PCT Filed: Nov. 30, 2023
(86) PCT No.: PCT/CN2023/135695

§ 371 Date: May 30, 2025

(30) Foreign Application Priority Data
Dec. 1, 2022 (CN) 202211544804.9
Dec. 1, 2022 (CN) 202223233526.3
Dec. 1, 2022 (CN) 202223234023.8
Dec. 1, 2022 (CN) 202223234176.2

(51) Int. Cl. H01H 50/54; H01H 50/58; H01H 51/22; H01H 51/29

(52) U.S. Cl. CPC H01H 50/541; H01H 50/58; H01H 51/2209; H01H 51/29

(57) ABSTRACT

An auxiliary contact assembly, applied to relays, includes an auxiliary movable contact piece comprises a movable contact terminal; and an auxiliary static contact piece having a needle-shaped structure, along an axial direction of the needle-shaped structure, the auxiliary static contact piece comprises a static contact lead-out terminal and a static contact terminal, wherein a side surface of the static contact terminal is configured to contact or separate from the movable contact terminal.

### CROSS-REFERENCE

The present disclosure is the U.S. national phase application of International Application No. PCT/CN2023/135695, filed on Nov. 30, 2023, which claims priority to Chinese Patent Application No. 202211544804.9, No. 202223233526.3, No. 202223234176.2, and No. 202223234023.8, all filed on Dec. 1, 2022, each of these applications is herein incorporated by reference in its entirety.

### TECHNICAL FIELD

The embodiments of the present disclosure relate to the field of electronic control devices, and in particular, to a relay.

### BACKGROUND

A relay is an electronic control device having a control system (also called an input circuit) and a controlled system (also called an output circuit), and is typically used in automatic control circuits. In essence, a relay uses a smaller current to control a larger current, functioning as an automatic switch. Therefore, the relay plays roles such as automatic regulation, safety protection, and circuit conversion in circuits.

During the contact closing process of the relay, the push rod drives the movable contact piece to move toward the static contact piece until the movable contact piece comes into contact with the static contact piece. During the contact separation process of the relay, the push rod drives the movable contact piece to move away from the static contact piece until the push rod returns to the initial position. In the prior art, the connection structure between the push rod and the movable contact piece is not stable enough, resulting in unsteady movement of the movable contact piece during the contact separation process.

In addition, relays are usually equipped with an anti-short circuit structure to prevent the contacts from bouncing off due to large short-circuit loads. Specifically, a magnetizer is installed inside the relay. When a short-circuit current generates electromagnetic repulsion force, the magnetizer becomes magnetized and produces electromagnetic attraction force, thereby preventing the movable contact piece from bouncing off instantaneously and avoiding relay burnout or explosion.

In the prior art, inverted U-shaped yokes or stopping plates are typically placed directly above the movable contact piece to ensure smooth movement of the movable contact piece. However, the magnetizer of the anti-short circuit structure is also arranged directly above the movable contact piece, meaning that parts of the U-shaped yoke or stopping plates exist between the movable contact piece and the magnetizer, which affects the magnetic field strength of the anti-short circuit structure.

### SUMMARY

According to one aspect of the present disclosure, a relay includes: a housing; a first magnetizer, fixedly connected to the housing and located at a side of a movable contact piece facing a static contact piece; a contact assembly, including the movable contact piece and the static contact piece, wherein the static contact piece is fixedly connected to the housing, and the movable contact piece is arranged inside the housing; and a push rod, movable relative to the housing; wherein the push rod includes a rod portion, a bottom portion, a first side portion, and a second side portion, the bottom portion is connected to an end of the rod portion in an axial direction, the first side portion and the second side portion are both connected to the bottom portion and arranged opposite each other along a length direction of the movable contact piece; the first side portion is provided with a first through hole, the second side portion is provided with a second through hole, and the movable contact piece passes through the first through hole and the second through hole; along the axial direction of the rod portion, the movable contact piece is movable between a first position and a second position relative to the first through hole and the second through hole; in the first position, the movable contact piece abuts against a hole wall of the first through hole and a hole wall of the second through hole; along the axial direction of the rod portion, the movable contact piece has a magnetic conduction area corresponding to the first magnetizer, and no part of the push rod is accommodated between the magnetic conduction area and the first magnetizer.

According to some embodiments of the present disclosure, the relay further includes: a first elastic component, connected between the movable contact piece and the push rod, configured to apply an elastic force to the movable contact piece toward the first position.

According to some embodiments of the present disclosure, the magnetic conduction area is located between the first side portion and the second side portion.

According to some embodiments of the present disclosure, two end portions of the movable contact piece along the length direction are each provided with a movable contact, one of the movable contacts is located at a side of the first side portion facing away from the second side portion, and another movable contact is located at a side of the second side portion facing away from the first side portion; the magnetic conduction area is located between two movable contacts.

According to some embodiments of the present disclosure, a side of the movable contact piece protrudes with a first positioning portion and a second positioning portion, the first positioning portion corresponds to a position of the first side portion, and the second positioning portion corresponds to a position of the second side portion; along the length direction of the movable contact piece, the movable contact piece is arranged at a predetermined position of the push rod through the first positioning portion and the second positioning portion.

According to some embodiments of the present disclosure, the first side portion has a first stopping surface facing the second side portion, and the second side portion has a second stopping surface facing the first side portion; the first positioning portion abuts against the first stopping surface, and the second positioning portion abuts against the second stopping surface.

According to some embodiments of the present disclosure, the first positioning portion and the second positioning portion protrude from a surface of the movable contact piece facing the static contact piece.

According to some embodiments of the present disclosure, the relay further includes a second magnetizer, wherein the second magnetizer is located at the magnetic conduction area of the movable contact piece and fixedly connected to a side of the movable contact piece facing away from the first magnetizer, so that a magnetic conduction circuit is formed between the first magnetizer and the second magnetizer along a width direction of the movable contact piece; wherein, along the axial direction of the rod portion, no part of the push rod is accommodated between the second magnetizer and the first magnetizer.

According to some embodiments of the present disclosure, the second magnetizer is U-shaped and encloses the magnetic conduction area along the width direction of the movable contact piece.

According to some embodiments of the present disclosure, the second magnetizer includes at least two sub-magnetizers, each of the sub-magnetizers is U-shaped; the movable contact piece is provided with at least one perforation, the at least two sub-magnetizers are connected to a side of the movable contact piece facing away from the first magnetizer, and side portions of the at least two sub-magnetizers pass through the at least one perforation to approach or contact the first magnetizer through the perforation, forming at least two independent magnetic conduction circuits along the width direction of the movable contact piece.

According to some embodiments of the present disclosure, a gap exists between two of the side portions located in one of the perforations.

According to some embodiments of the present disclosure, the housing has a mounting part, the mounting part is located at a side of the push rod in a radial direction, and the radial direction is perpendicular to a movement direction of the push rod; the first magnetizer is fixedly connected to the mounting part.

According to some embodiments of the present disclosure, the housing includes a side wall, the side wall is located at the side of the push rod in the radial direction, and the mounting part is proposed on the side wall.

According to some embodiments of the present disclosure, the side wall surrounds the push rod along a circumferential direction of the push rod.

According to some embodiments of the present disclosure, the housing includes: a base; and a cover, connected to the base, wherein the cover and the base together form a chamber for accommodating the contact assembly, the push rod, and the first magnetizer; the side wall is formed by the base and/or the cover.

According to some embodiments of the present disclosure, the first magnetizer includes a connection portion and an overhang portion, the connection portion is fixedly connected to the mounting part; wherein, defining a virtual plane perpendicular to the movement direction of the push rod, the connection portion has a first orthographic projection on the virtual plane, the overhang portion has a second orthographic projection on the virtual plane, and the movable contact piece has a third orthographic projection on the virtual plane; the first orthographic projection does not overlap with the third orthographic projection, and the second orthographic projection at least partially overlaps with the third orthographic projection.

According to some embodiments of the present disclosure, the first magnetizer is a flat plate structure.

According to some embodiments of the present disclosure, the first magnetizer is inserted into the mounting part of the housing along an insertion direction, and the insertion direction is perpendicular to the movement direction of the push rod.

According to some embodiments of the present disclosure, the mounting part includes a first mounting hole, the first mounting hole penetrates an inner surface and an outer surface of the housing, and a hole wall of the first mounting hole has a first positioning wall structure and a first gap wall structure; the first magnetizer is inserted into the first mounting hole, part of an outer wall surface of the first magnetizer abuts against the first positioning wall structure, and a gap exists between another part of the outer wall surface of the first magnetizer and the first gap wall structure, the gap is filled with a sealant.

According to some embodiments of the present disclosure, part of the outer wall surface of the first magnetizer is in interference fit with the first positioning wall structure.

According to some embodiments of the present disclosure, the insertion direction of the first magnetizer is perpendicular to the length direction of the movable contact piece.

According to some embodiments of the present disclosure, the static contact piece is inserted into the housing along the insertion direction.

According to some embodiments of the present disclosure, the housing further has a second mounting hole penetrating an inner surface and an outer surface of the housing, and a hole wall of the second mounting hole has a second positioning wall structure and a second gap wall structure; the static contact piece is inserted into the second mounting hole, part of an outer wall surface of the static contact piece abuts against the second positioning wall structure, and a gap exists between another part of the outer wall surface of the static contact piece and the second gap wall structure, the gap is filled with a sealant.

According to some embodiments of the present disclosure, part of the outer wall surface of the static contact piece is in interference fit with the second positioning wall structure.

According to some embodiments of the present disclosure, a portion of the outer wall surface of the static contact piece is in interference fit with the second positioning wall structure.

### BRIEF DESCRIPTION OF DRAWINGS

The above and other features and advantages of the present disclosure will become more apparent by describing in detail exemplary embodiments with reference to the accompanying drawings.

FIG. 1 shows a top view of an embodiment of the relay of the present disclosure, in which the cover is omitted.

FIG. 2 shows a cross-sectional view taken along line A-A in FIG. 1.

FIG. 3 shows a cross-sectional view taken along line B-B in FIG. 2.

FIG. 4 shows a schematic diagram of the push rod.

FIG. 5 shows a front view of the assembled push rod, contact assembly, and yoke plate.

FIG. 6 shows a perspective view of the assembled push rod, contact assembly, and yoke plate.

FIG. 7 shows a side view of FIG. 5.

FIG. 8 shows a cross-sectional view taken along line C-C in FIG. 7.

FIG. 9 shows a schematic diagram of the relative positions of the first orthographic projection, second orthographic projection, and third orthographic projection on the virtual plane.

FIG. 10 shows a cross-sectional view taken along line D-D in FIG. 2.

FIG. 11 shows a partial enlarged view of area X1 in FIG. 10.

FIG. 12 shows a partial enlarged view of area X2 in FIG. 10.

FIG. 13 shows a schematic diagram of the assembled first magnetizer, second magnetizer, and contact assembly in the first embodiment of the present disclosure.

FIG. 14 and FIG. 15 respectively show schematic diagrams of the assembled movable contact piece and second magnetizer in the second embodiment of the present disclosure from two different perspectives.

FIG. 16 and FIG. 17 show schematic diagrams of the elastic component in the embodiments of the present disclosure from two different perspectives.

FIG. 18 shows a top view of another embodiment of the relay of the present disclosure, in which the upper cover is omitted.

FIG. 19 shows a cross-sectional view taken along line E-E in FIG. 18.

FIG. 20 shows a cross-sectional view taken along line F-F in FIG. 19.

FIG. 21 shows a schematic diagram of the push rod.

FIG. 22 shows a front view of the assembled push rod, contact assembly, and yoke plate.

FIG. 23 shows a perspective view of the assembled push rod, contact assembly, and yoke plate.

FIG. 24 shows a side view of FIG. 22.

FIG. 25 shows a cross-sectional view taken along line G-G in FIG. 24.

FIG. 26 and FIG. 27 show schematic diagrams of the first elastic component from two different perspectives.

FIG. 28 shows a top view of another embodiment of the relay of the present disclosure, in which the upper cover is omitted.

FIG. 29 shows a cross-sectional view taken along line H-H in FIG. 28.

FIG. 30 shows a cross-sectional view taken along line I-I in FIG. 29.

FIG. 31 shows a schematic diagram of the auxiliary contact assembly disposed at one end of the push rod mechanism in the relay of the embodiments of the present disclosure.

FIG. 32 shows a schematic diagram of the auxiliary movable contact piece in the embodiments of the present disclosure.

FIG. 33 shows a schematic diagram of the auxiliary static contact piece in the embodiments of the present disclosure.

FIG. 34 shows a schematic diagram of the assembled push rod and auxiliary contact assembly.

FIG. 35 shows a top view of another embodiment of the relay of the present disclosure, in which the upper cover is omitted.

FIG. 36 shows a cross-sectional view taken along line J-J in FIG. 35.

FIG. 37 shows a cross-sectional view taken along line K-K in FIG. 36.

FIG. 38 shows a cross-sectional view taken along line M-M in FIG. 36.

FIG. 39 shows a partial enlarged view of area X3 in FIG. 38.

FIG. 40 shows a cross-sectional view taken along line N-N in FIG. 35.

FIG. 41 shows a partial enlarged view of area X4 in FIG. 40.

FIG. 42 shows a cross-sectional view taken along line P-P in FIG. 35.

FIG. 43 shows a partial enlarged view of area X5 in FIG. 42.

FIG. 44 shows a perspective view of the relay of the embodiments of the present disclosure, with the bottom surface of the base facing upward.

### DETAILED DESCRIPTION

Example embodiments will now be described more fully with reference to the accompanying drawings. However, the example embodiments can be implemented in various forms and should not be construed as limited to the embodiments set forth herein. Although relative terms such as “upper” and “lower” are used in this specification to describe the relative relationship of one component of an icon to another component, these terms are used in this specification for convenience only, for example, according to the direction of the example described in the accompanying drawings. It should be understood that if the device of the icon is turned upside down, the component described as being “upper” will become a “lower” component. Other relative terms such as “top” and “bottom” have similar meanings. When a structure is “on” another structure, it may mean that the structure is integrally formed on the other structure, or that the structure is “directly” disposed on the other structure, or that the structure is “indirectly” disposed on the other structure through another structure.

In the embodiments of the invention, the terms “a”, “an”, “the” and “said” are used to indicate the presence of one or more elements/components/etc.; the terms “comprise” and “have” are used to indicate an open-ended inclusive meaning and mean that in addition to the listed elements/components/etc., there may be additional elements/components/etc.; the terms “first”, “second”, etc. are used only as labels and are not limitations on the quantity of their objects.

In the embodiments of the invention, the terms “first”, “second”, and “third” are used for descriptive purposes only and should not be construed as indicating or implying relative importance; the term “plurality” refers to two or more, unless otherwise explicitly defined. Terms such as “mount”, “connect”, “join”, and “fix” should be understood broadly. For example, “connect” may be a fixed connection, a detachable connection, or an integral connection; “connected” may be directly connected or indirectly connected through an intermediate medium. For those of ordinary skill in the art, the specific meanings of the above terms in the embodiments of the invention can be understood according to specific circumstances.

In the description of this specification, the descriptions of terms such as “one embodiment”, “some embodiments”, and “specific embodiments” mean that the specific features, structures, materials, or characteristics described in connection with the embodiment or example are included in at least one embodiment or example of the embodiments of the invention. In this specification, the schematic expressions of the above terms do not necessarily refer to the same embodiment or example. Moreover, the described specific features, structures, materials, or characteristics may be combined in any one or more embodiments or examples in a suitable manner.

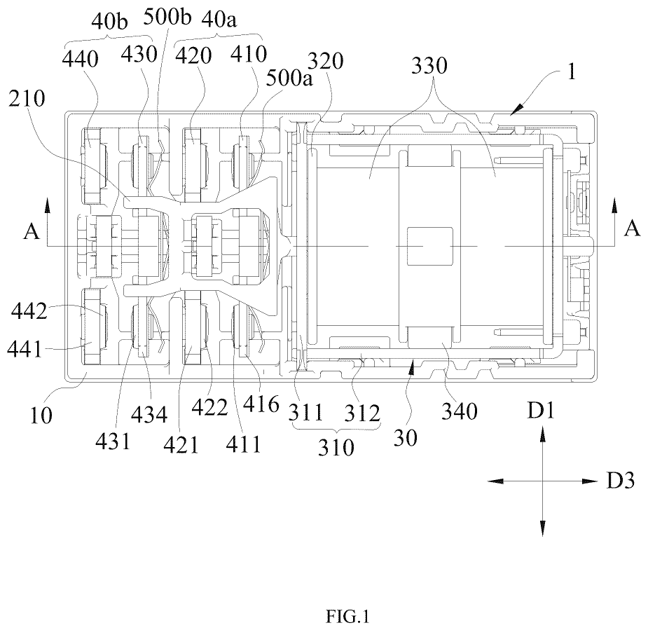

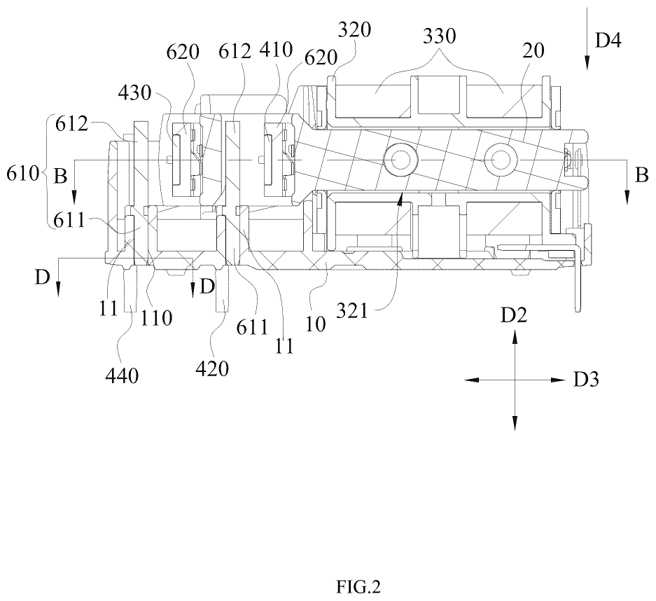

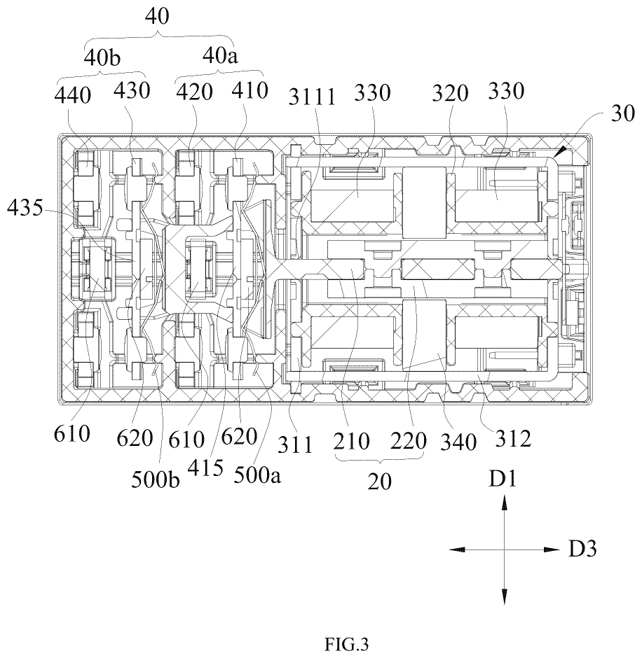

As shown in FIG. 1 to FIG. 3, FIG. 1 shows a top view of the relay of the embodiments of the present disclosure, in which the cover is omitted, FIG. 2 shows a cross-sectional view taken along line A-A in FIG. 1, and FIG. 3 shows a cross-sectional view taken along line B-B in FIG. 2. The relay of the embodiments of the present disclosure includes a housing 1, a push rod mechanism 20, a magnetic circuit mechanism 30, and a contact assembly 40. In the embodiments of the present disclosure, the housing 1 is the housing of the relay. The push rod mechanism 20, magnetic circuit mechanism 30, and contact assembly 40 are disposed on the base 10, and the magnetic circuit mechanism 30 controls the contacts of the contact assembly 40 to contact or separate through the push rod mechanism 20.

The housing 1 includes a base 10 and a cover (not shown in the FIG.). The cover is connected to the base 10 to form a chamber for accommodating the push rod mechanism 20, magnetic circuit mechanism 30, and contact assembly 40.

The magnetic circuit mechanism 30 includes a yoke structure 310, a bobbin 320, and a coil 330. The yoke structure 310 forms a chamber, and the bobbin 320 and coil 330 are both disposed in the chamber of the yoke structure 310. The coil 330 is wound around the periphery of the bobbin 320 to form a magnetic control circuit. The bobbin 320 is provided with a center hole 321 in the contact-separation direction of the contact assembly 40, and the center hole 321 is used for the push rod mechanism 20 to pass through.

As an example, the yoke structure 310 includes a yoke plate 311 and a U-shaped yoke 312. The yoke plate 311 and the U-shaped yoke 312 are connected to form a ring. The yoke plate 311 is provided with a through hole 3111, and the through hole 3111 is used for the push rod mechanism 20 to pass through.

Of course, in other embodiments, the yoke structure 310 may also include a cylindrical yoke and the yoke plate 311, and the cylindrical yoke and the yoke plate 311 are connected to form a ring.

The magnetic circuit mechanism 30 further includes two permanent magnets 340. The two permanent magnets 340 are disposed on the bobbin 320 and located at both sides of the movement direction of the push rod mechanism 20. The two permanent magnets 340 form a magnetic holding circuit structure, which is beneficial for reducing power consumption, extending service life, and improving stability.

Of course, in other embodiments, the permanent magnets 340 may not be included.

As shown in FIG. 3, the push rod mechanism 20 is movable relative to the base 10 between a fifth position and a sixth position. When the push rod mechanism 20 is in the fifth position, the contact assembly 40 is in a fully closed state. When the push rod mechanism 20 is in the sixth position, the contact assembly 40 is in a fully open state. The push rod mechanism 20 includes a push rod 210 and an iron core 220. The iron core 220 is connected to the push rod 210. The iron core 220 can move in the contact-separation direction under the action of the magnetic control circuit formed by the coil 330, thereby driving the push rod 210 to move to control the contact or separation of the contacts of the contact assembly 40 to contact or separate.

It should be noted that the fully closed state of the contact assembly 40 means the state of the contact assembly 40 when the movable contact piece and the static contact piece of the contact assembly 40 are in contact and the overtravel is completed. The fully open state of the contact assembly 40 means the state of the contact assembly 40 when the movable contact piece and the static contact piece of the contact assembly 40 are separated and the contact gap is maximum.

Please continue to refer to FIG. 1 to FIG. 3. The contact assembly 40 includes movable contact pieces 410, 430 and static contact pieces 420, 440. The static contact pieces 420, 440 are fixedly installed on the base 10, and the movable contact pieces 410, 430 are disposed in the housing 1 and installed on the push rod mechanism 20 to move with the push rod mechanism 20.

In this embodiment, the contact assembly 40 includes two groups, namely a first contact assembly 40a and a second contact assembly 40b. The first contact assembly 40a and the second contact assembly 40b are arranged along the movement direction of the push rod mechanism 20. Moreover, the first contact assembly 40a is close to the magnetic circuit mechanism 30, and the second contact assembly 40b is far from the magnetic circuit mechanism 30.

The first contact assembly 40a includes a first movable contact piece 410 and two first static contact pieces 420. The second contact assembly 40b includes a second movable contact piece 430 and two second static contact pieces 440. The two ends of the first movable contact piece 410 can respectively contact with or separated from the two first static contact pieces 420, and the two ends of the second movable contact piece 430 can respectively contact with or separated from the two second static contact pieces 440.

Of course, in other embodiments, the contact assembly 40 may be one group or other numbers.

The two ends of the movable contact pieces 410, 430 in the length direction serve as movable contacts. The movable contacts may protrude from other parts of the movable contact pieces 410, 430 or may be flush with other parts. The parts of the static contact pieces 420, 440 in contact with the movable contacts serve as static contacts. The static contacts may protrude from other parts of the static contact pieces 420, 440 or may be flush with other parts.

As an example, the first movable contact piece 410 includes a first movable piece body 416 and a first movable contact 411. The first movable contact 411 and the first movable piece body 416 are separate structures. The first movable contact 411 and the first movable piece body 416 may be connected by riveting, but are not limited to this. The first static contact piece 420 includes a first static piece body 421 and a first static contact 422. The first static contact 422 and the first static piece body 421 are separate structures. The first static contact 422 and the first static piece body 421 may be connected by riveting, but are not limited to this.

The second movable contact piece 430 includes a second movable piece body 434 and a second movable contact 431. The second movable contact 431 and the second movable piece body 434 are separate structures. The second movable contact 431 and the second movable piece body 434 may be connected by riveting, but are not limited to this. The second static contact piece 440 includes a second static piece body 441 and a second static contact 442. The second static contact 442 and the second static piece body 441 are separate structures. The second static contact 442 and the second static piece body 441 may be connected by riveting, but are not limited to this.

Of course, in another embodiment, the first movable contact 411 and the first movable piece body 416 may be an integrated structure; the first static contact 422 and the first static piece body 421 may be an integrated structure; the second movable contact 431 and the second movable piece body 434 may be an integrated structure; the second static contact 442 and the second static piece body 441 may be an integrated structure.

It can be understood that in other embodiments, the housing 1 may also be a ceramic cover.

As shown in FIG. 2 and FIG. 3, the housing 1 has a mounting part 11. The mounting part 11 is located at one side of the push rod mechanism 20 in the radial direction, and the radial direction is perpendicular to the movement direction D3 of the push rod mechanism 20. The relay of the embodiments of the present disclosure further includes a first magnetizer 610. The first magnetizer 610 corresponds to the contact assembly 40, that is, it is located at the side of the movable contact piece facing the static contact piece. The first magnetizer 610 is fixedly connected to the base 10.

The first magnetizer 610 corresponding to the contact assembly 40 means that the number of the first magnetizer 610 corresponds to the number of the contact assembly 40, and the position of the first magnetizer 610 corresponds to the position of the contact assembly 40. In this embodiment, the number of the contact assembly 40 is two, so the number of the first magnetizer 610 is also two. One first magnetizer 610 corresponds to the first movable contact piece 410 of the first contact assembly 40a, and the other first magnetizer 610 corresponds to the second movable contact piece 430 of the second contact assembly 40b.

The relay according to embodiments of the present disclosure can be understood as follows: since the mounting part 11 of the housing 1 is located at one side of the push rod mechanism 20 in the radial direction, the radial direction is perpendicular to the movement direction of the push rod mechanism 20, the connection position between the first magnetizer 610 and the mounting part 11 is also located at one side of the push rod mechanism 20. This means the connection position is not above the movable contact piece. Therefore, after installing multiple first magnetizers 610 in the relay, none of them will affect the movement of the push rod mechanism 20. Thus, in this embodiment, one first magnetizer 610 is provided for each of the multiple contact assemblies 40, thereby providing an anti-short circuit structure for every contact assembly 40.

The housing 1 comprises a top wall, bottom wall and side wall. The top wall and bottom wall are arranged opposite each other along the movement direction of the push rod mechanism 20, with the side wall connecting them. The side wall is located at one side of the push rod mechanism 20 in the radial direction, and the mounting part 11 is formed on the side wall.

Furthermore, the side wall surrounds the push rod mechanism 20 along its circumferential direction.

It should be understood that the shape of housing 1 may have various embodiments. For example, the housing 1 could be a cube, cylinder, etc., but is not limited to these.

The base 10 and/or the cover of housing 1 forms the side wall containing the mounting part 11. Specifically, the mounting part 11 may be formed only on the base 10, or only on the cover, or on both.

It should be understood that, in this embodiment, the first magnetizer 610 is positioned above the movable contact pieces 410,430. When the movable contact pieces 410,430 contact the static contact pieces 420,440, current flows through the movable contact pieces 410,430, forming a magnetic conduction circuit around the outer periphery in width direction D2 of the movable contact pieces 410,430. The first magnetizer 610 concentrates most of this magnetic field and becomes magnetized, creating an attractive force in the contact pressure direction between the first magnetizer 610 and the current-carrying movable contact pieces 410,430. The attractive force, when combined with the contact pressure, generates a greater contact pressure. This increased contact pressure can counteract the electromagnetic repulsive force generated between the movable contacts of the movable contact pieces 410, 430 and the static contacts of the static contact pieces 420, 440 due to short-circuit current, ensuring that the movable contacts of the movable contact pieces 410, 430 do not separate from the static contacts of the static contact pieces 420, 440. In addition, the first magnetizer 610 is fixedly connected to the base 10 and does not move with the push rod mechanism 20, This means that the attractive force between the movable contact pieces 410, 430 and the first magnetizer 610 acts on the base 10. Since the base 10 is relatively fixed in position, the attractive force of the first magnetizer 610 is independent of the push rod mechanism 20. This arrangement prevents the movable contact pieces 410, 430 from bouncing off from the static contact pieces 420, 440 due to insufficient holding force from the push rod mechanism 20, which could cause relay burnout or explosion.

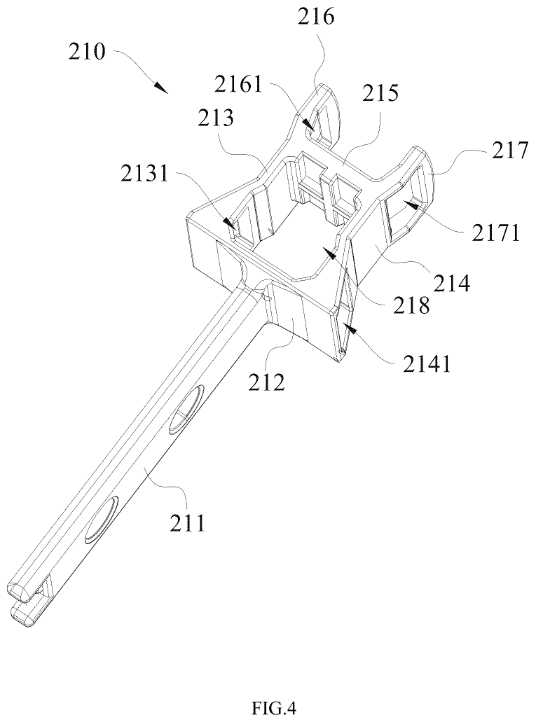

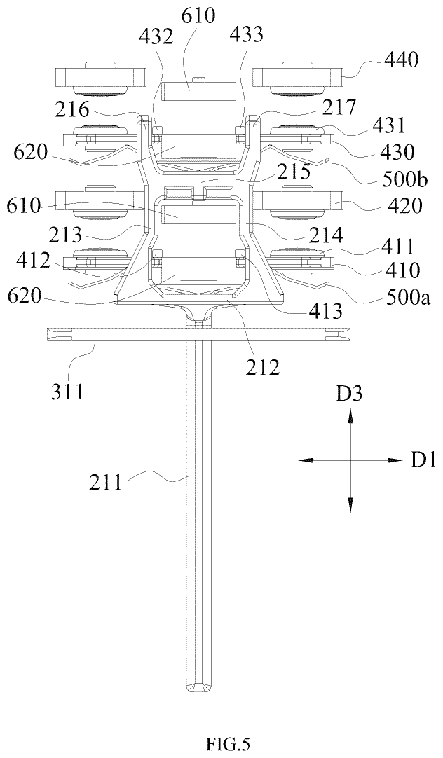

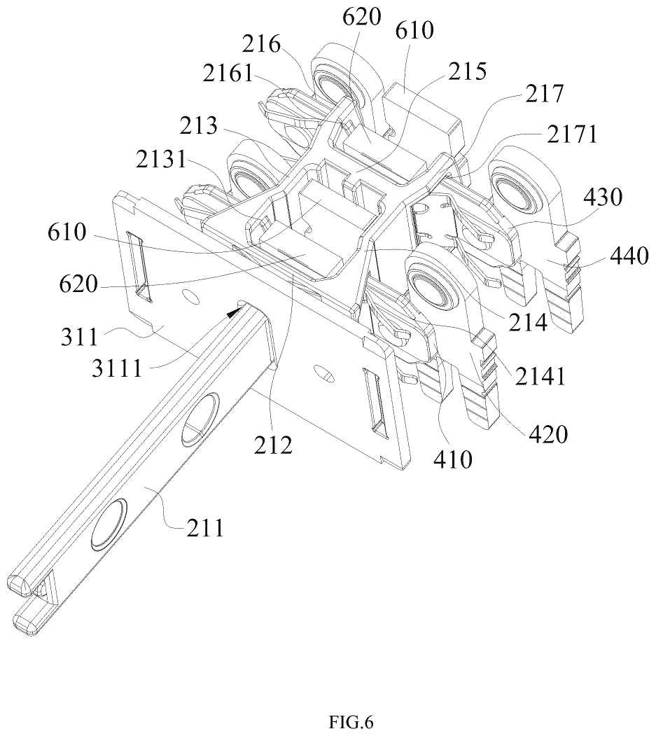

As shown in FIG. 4 to FIG. 6, FIG. 4 shows a schematic diagram of the push rod 210. FIG. 5 shows a front view of the assembled push rod 210, contact assembly 40 and yoke plate 311. FIG. 6 shows a perspective view of the assembled push rod 210, contact assembly 40 and yoke plate 311. The push rod 210 is used to drive the first movable contact piece 410 to move to contact or separate from the first static contact piece 420. The push rod 210 includes a rod portion 211, a bottom portion 212, a first side portion 213 and a second side portion 214. The rod portion 211 is movably inserted through the through hole 3111 of the yoke plate 311, and the iron core 220 is connected to the rod portion 211. The bottom portion 212 is connected to one axial end of the rod portion 211, and the first side portion 213 and the second side portion 214 are both connected to the bottom portion 212 and are arranged opposite to each other along the length direction D1 of the first movable contact piece 410. The first side portion 213 is provided with a first through hole 2131, and the second side portion 214 is provided with a second through hole 2141. The first movable contact piece 410 passes through the first through hole 2131 and the second through hole 2141, and is movable between a first position and a second position along the axial direction of the rod portion 211 relative to the first through hole 2131 and the second through hole 2141. In the first position, the first movable contact piece 410 abuts against the hole walls of the first through hole 2131 and the second through hole 2141, respectively.

The relay further includes a first elastic component 500a. The first elastic component 500a is disposed between the first movable contact piece 410 and the bottom portion 212 of the push rod 210, and is used to apply an elastic force to the first movable contact piece 410 toward the first position.

During the closing process of the first contact assembly 40a of the relay, the push rod 210 drives the first movable contact piece 410 to move toward the first static contact piece 420. Before the first movable contact piece 410 contacts the first static contact piece 420, under the action of the first elastic component 500a, the first movable contact piece 410 abuts against the hole walls of the first through hole 2131 and the second through hole 2141 and is in the first position. After the first movable contact piece 410 contacts the first static contact piece 420, since the first static contact piece 420 is fixedly installed on the base 10, the first movable contact piece 410 is blocked by the first static contact piece 420 and cannot continue to move. At this time, the push rod 210 continues to move, and the first elastic component 500a is gradually compressed until the overtravel is completed. At this time, the first movable contact piece 410 is in the second position relative to the first through hole 2131 and the second through hole 2141.

During the separation process of the first contact assembly 40a of the relay, the movement process of the push rod 210 away from the first static contact piece 420 can be divided into two stages: In the first stage, the push rod 210 moves while the first movable contact piece 410 does not move with the push rod 210. In the first stage, the first movable contact piece 410 moves from the second position to the first position relative to the first through hole 2131 and the second through hole 2141. At the beginning of the second stage, the first movable contact piece 410 has moved to the first position relative to the first through hole 2131 and the second through hole 2141, and the first movable contact piece 410 abuts against the hole walls of the first through hole 2131 and the second through hole 2141, respectively. After that, the movement of the push rod 210 will drive the first movable contact piece 410 to move accordingly, so that the first movable contact piece 410 is separated from the first static contact piece 420. In the second stage, when the push rod 210 drives the first movable contact piece 410 to move, since the first movable contact piece 410 abuts against the hole walls of the first through hole 2131 and the second through hole 2141, respectively, it is equivalent to the push rod 210 acting on the first movable contact piece 410 through the first side portion 213 and the second side portion 214, so that the first movable contact piece 410 is separated from the first static contact piece 420.

It can be seen that the position where the hole wall of the first through hole 2131 abuts against the first movable contact piece 410 is equivalent to one force application point, and the position where the hole wall of the second through hole 2141 abuts against the first movable contact piece 410 is equivalent to another force application point. By setting two force application points, and the two force application points are arranged along the length direction D1 of the first movable contact piece 410, the pulling force area of the first movable contact piece 410 subjected to the push rod 210 is larger, making the movement of the first movable contact piece 410 driven by the push rod 210 more stable.

As shown in FIG. 3, along the axial direction of the rod portion 211 (that is, the movement direction D3 of the push rod mechanism 20), the first movable contact piece 410 has a magnetic conduction area 415 corresponding to the first magnetizer 610, and the push rod 210 does not have any part between the magnetic conduction area 415 and the first magnetizer 610.

From this, it can be seen that, on one hand, when the push rod 210 drives the first movable contact piece 410 to move, the push rod 210 forms two pulling force points with the first movable contact piece 410 through the first side portion 213 and the second side portion 214, and the two pulling force points are arranged along the length direction D1 of the first movable contact piece 410, making the movement of the first movable contact piece 410 more stable; on the other hand, in the movement direction D3 of the push rod mechanism 20, the push rod 210 does not have any part between the magnetic conduction area 415 of the first movable contact piece 410 and the first magnetizer 610, avoiding the influence of the push rod 210 on the magnetic field strength between the first movable contact piece 410 and the first magnetizer 610, and ensuring the anti-short circuit capability.

The magnetic conduction area 415 of the first movable contact piece 410 is located between the first side portion 213 and the second side portion 214.

As shown in FIG. 5, both ends of the first movable contact piece 410 in the length direction D1 are provided with first movable contacts 411, one of which is located at the side of the first side portion 213 opposite to the second side portion 214, and the other is located at the side of the second side portion 214 opposite to the first side portion 213. That is to say, the two force application points of the first side portion 213 and the second side portion 214 acting on the first movable contact piece 410 are located between the two first movable contacts 411 of the first movable contact piece 410. The magnetic conduction area 415 is located between the two first movable contacts 411.

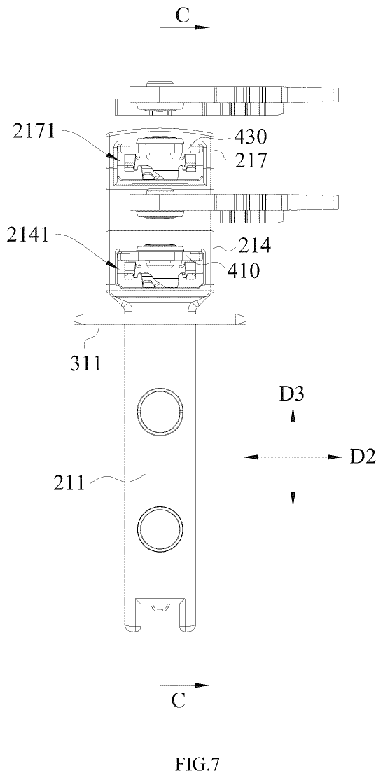

As shown in FIG. 7 and FIG. 8, FIG. 7 shows a side view of FIG. 5. FIG. 8 shows a cross-sectional view taken along line C-C in FIG. 7. One side of the first movable contact piece 410 protrudes with a first positioning portion 412 and a second positioning portion 413, which correspond to the positions of the first side portion 213 and the second side portion 214, respectively. In the length direction D1 of the first movable contact piece 410, the first movable contact piece 410 is set at a predetermined position of the push rod 210 through the first positioning portion 412 and the second positioning portion 413.

In this embodiment, by setting the first positioning portion 412 and the second positioning portion 413 on the first movable contact piece 410, the first movable contact piece 410 can be installed at the predetermined position of the push rod 210 in its length direction D1, avoiding relative shaking between the first movable contact piece 410 and the first side portion 213 and the second side portion 214, and further improving the stability of the first movable contact piece 410 during movement.

Specifically, in the axial direction of the rod portion 211 (that is, the movement direction D3 of the push rod mechanism 20), the first elastic component 500a is disposed between the bottom portion 212 of the push rod 210 and the first movable contact piece 410, and the first movable contact piece 410 is always subjected to the elastic force of the first elastic component 500a, so that the first movable contact piece 410 abuts against the hole walls of the first through hole 2131 and the second through hole 2141, respectively. Therefore, in the axial direction of the rod portion 211 (that is, the movement direction D3 of the push rod mechanism 20), there will be no relative shaking between the first movable contact piece 410 and the push rod 210.

In the length direction D1 of the first movable contact piece 410, through the setting of the first positioning portion 412 and the second positioning portion 413, there will also be no relative shaking between the first movable contact piece 410 and the push rod 210.

In the width direction D2 of the first movable contact piece 410, the sizes of the first through hole 2131 and the second through hole 2141 can be designed, so that in the width direction D2 of the first movable contact piece 410, the sizes of the first through hole 2131 and the second through hole 2141 are adapted to the width of the first movable contact piece 410, avoiding large gaps between the first movable contact piece 410 and the hole walls of the first and second through holes.

Please continue to refer to FIG. 8. The side of the first side portion 213 facing the second side portion 214 has a first stopping surface 2132, and the side of the second side portion 214 facing the first side portion 213 has a second stopping surface 2142. The first positioning portion 412 abuts against the first stopping surface 2132, and the second positioning portion 413 abuts against the second stopping surface 2142.

Of course, in other embodiments, there may be gaps between the first positioning portion 412 and the first stopping surface 2132, and between the second positioning portion 413 and the second stopping surface 2142. It should be noted that the sizes of the above two gaps should not be too large. The size of the gaps should not only allow the first positioning portion 412 and the second positioning portion 413 of the first movable contact piece 410 to be easily installed between the first side portion 213 and the second side portion 214, but also avoid relative shaking between the first movable contact piece 410 and the push rod 210 in the length direction D1 of the first movable contact piece 410.

The first positioning portion 412 and the second positioning portion 413 protrude from the surface of the first movable contact piece 410 facing the first static contact piece 420.

Please return to refer to FIG. 4 to FIG. 6. The second contact assembly 40b is arranged along the axial direction of the rod portion 211 (namely the movement direction D3 of the push rod mechanism 20) relative to the first contact assembly 40a. The push rod 210 further includes a spacing portion 215, a third side portion 216 and a fourth side portion 217. The third side portion 216 connects to the end of the first side portion 213 opposite to the bottom portion 212, the fourth side portion 217 connects to the end of the second side portion 214 opposite to the bottom portion 212, and the spacing portion 215 is arranged between the third side portion 216 and the fourth side portion 217. The third side portion 216 has a third through hole 2161, the fourth side portion 217 has a fourth through hole 2171, and the second movable contact piece 430 passes through the third through hole 2161 and the fourth through hole 2171. The third through hole 2161 is located at one side of the spacing portion 215 along the axial direction of the rod portion 211, and the first through hole 2131 is located at the other side of the spacing portion 215 along the axial direction of the rod portion 211. The fourth through hole 2171 is located at one side of the spacing portion 215 along the axial direction of the rod portion 211, and the second through hole 2141 is located at the other side of the spacing portion 215 along the axial direction of the rod portion 211. Along the axial direction of the rod portion 211 (namely the movement direction D3 of the push rod mechanism 20), the second movable contact piece 430 is movable between a third position and a fourth position relative to the third through hole 2161 and the fourth through hole 2171. In the third position, the second movable contact piece 430 abuts against the hole walls of the third through hole 2161 and the fourth through hole 2171 respectively.

The relay further includes a second elastic component 500b, the second elastic component 500b is arranged between the second movable contact piece 430 and the spacing portion 215, and is used to apply an elastic force to the second movable contact piece 430 toward the third position.

The action process of the push rod 210 driving the second movable contact piece 430 to contact or separate from the first static contact piece 420 is the same as that of the first contact assembly 40a, which will not be repeated here.

Therefore, the position where the hole wall of the third through hole 2161 abuts against the second movable contact piece 430 is equivalent to one force application point, and the position where the hole wall of the fourth through hole 2171 abuts against the second movable contact piece 430 is equivalent to another force application point. By setting two force application points, and the two force application points are arranged along the length direction D1 of the second movable contact piece 430, the pulling force area of the second movable contact piece 430 subjected to the push rod 210 is larger, making the movement of the second movable contact piece 430 driven by the push rod 210 more stable.

As shown in FIG. 4, the bottom portion 212, the spacing portion 215, the first side portion 213 and the second side portion 214 together enclose a chamber 218, the first through hole 2131 and the second through hole 2141 are both communicated with the chamber 218, and the third through hole 2161 and the fourth through hole 2171 are not communicated with the chamber 218. The chamber 218 can be used to accommodate the anti-short circuit structure.

As shown in FIG. 5, both ends of the second movable contact piece 430 in the length direction D1 are provided with second movable contacts 431, one of which is located at the side of the third side portion 216 opposite to the fourth side portion 217, and the other is located at the side of the fourth side portion 217 opposite to the third side portion 216. That is to say, the two force application points of the third side portion 216 and the fourth side portion 217 acting on the second movable contact piece 430 are located between the two second movable contacts 431 of the second movable contact piece 430.

Please refer to FIG. 7 and FIG. 8, one side of the second movable contact piece 430 protrudes with a third positioning portion 432 and a fourth positioning portion 433, the third positioning portion 432 corresponds to the position of the third side portion 216, and the fourth positioning portion 433 corresponds to the position of the fourth side portion 217. In the length direction D1 of the second movable contact piece 430, the second movable contact piece 430 is set at a predetermined position of the push rod 210 through the third positioning portion 432 and the fourth positioning portion 433.

In this embodiment, by setting the third positioning portion 432 and the fourth positioning portion 433 on the second movable contact piece 430, the second movable contact piece 430 can be installed at the predetermined position of the push rod 210 in its length direction D1, avoiding relative shaking between the second movable contact piece 430 and the third side portion 216 and the fourth side portion 217, and further improving the stability of the second movable contact piece 430 during movement.

Specifically, in the axial direction of the rod portion 211 (namely the movement direction D3 of the push rod mechanism 20), the second elastic component 500b is arranged between the spacing portion 215 and the second movable contact piece 430, and the second movable contact piece 430 is always subjected to the elastic force of the second elastic component 500b, so that the second movable contact piece 430 abuts against the hole walls of the third through hole 2161 and the fourth through hole 2171 respectively. Therefore, in the axial direction of the rod portion 211 (namely the movement direction D3 of the push rod mechanism 20), there will be no relative shaking between the second movable contact piece 430 and the push rod 210.

In the length direction D1 of the second movable contact piece 430, through the setting of the third positioning portion 432 and the fourth positioning portion 433, there will also be no relative shaking between the second movable contact piece 430 and the push rod 210.

In the width direction D2 of the second movable contact piece 430, the sizes of the third through hole 2161 and the fourth through hole 2171 can be designed, so that in the width direction D2 of the second movable contact piece 430, the sizes of the third through hole 2161 and the fourth through hole 2171 are adapted to the width of the second movable contact piece 430, avoiding large gaps between the second movable contact piece 430 and the hole walls of the third and fourth through holes.

Please continue to refer to FIG. 8, the side of the third side portion 216 facing the fourth side portion 217 has a third stopping surface 2162, and the side of the fourth side portion 217 facing the third side portion 216 has a fourth stopping surface 2172. The third positioning portion 432 abuts against the third stopping surface 2162, and the fourth positioning portion 433 abuts against the fourth stopping surface 2172.

Of course, in other embodiments, there may be gaps between the third positioning portion 432 and the third stopping surface 2162, and between the fourth positioning portion 433 and the fourth stopping surface 2172.

The third positioning portion 432 and the fourth positioning portion 433 protrude from the surface of the second movable contact piece 430 facing the second static contact piece 440.

The rod portion 211, the bottom portion 212, the first side portion 213, the second side portion 214, the spacing portion 215, the third side portion 216 and the fourth side portion 217 of the push rod 210 are of an integrated structure.

As an example, the push rod 210 can be made of plastic and formed by injection molding.

The first elastic component 500a and the second elastic component 500b can be spring pieces, but are not limited to this.

It can be understood that the push rod 210 does not have any part between the magnetic conduction area 435 of the second movable contact piece 430 and its corresponding first magnetizer 610, and the magnetic field strength between the second movable contact piece 430 and its corresponding first magnetizer 610 is not affected by the push rod 210.

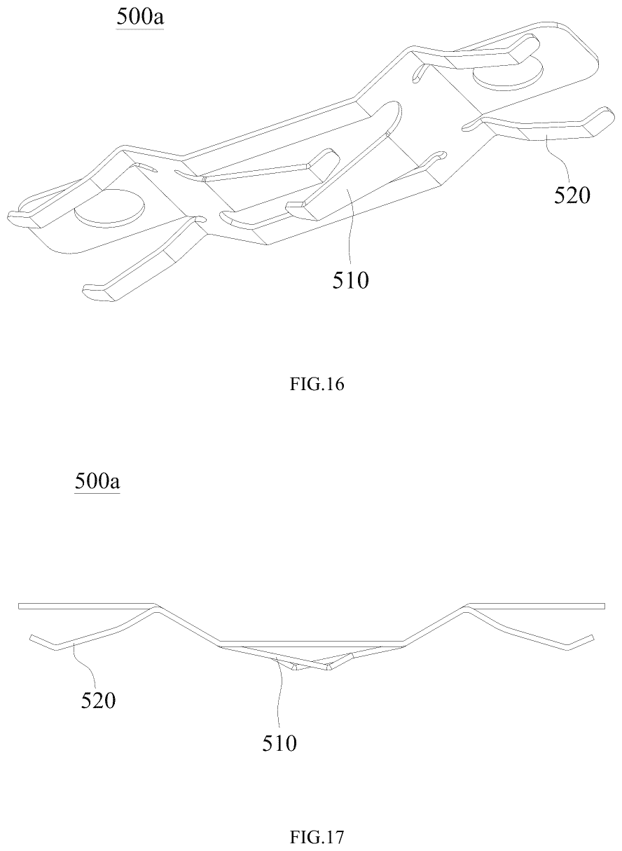

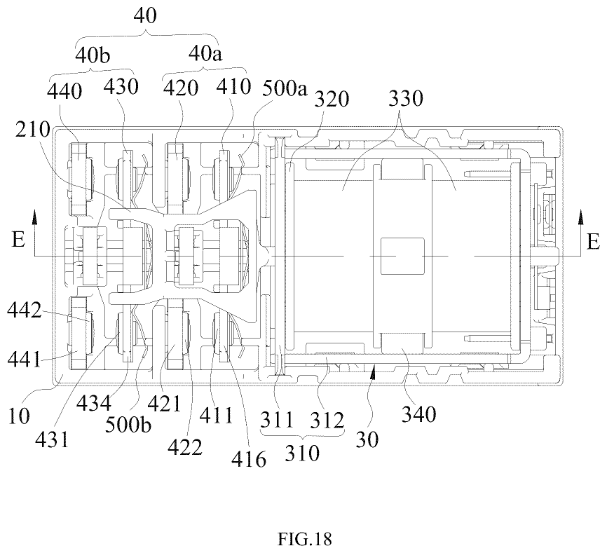

As shown in FIG. 5, FIG. 16 and FIG. 17, the first elastic component 500a includes a first elastic portion 510 and a second elastic portion 520, and the first elastic portion 510 and the second elastic portion 520 are of an integrated structure. The first movable contact piece 410 is arranged on the push rod 210 of the push rod mechanism 20 through the first elastic portion 510, the first elastic portion 510 is used to provide overtravel contact pressure when the push rod mechanism 20 is in the fifth position, and the second elastic portion 520 is used to provide elastic force to the push rod mechanism 20 toward the fifth position when the push rod mechanism 20 is in the sixth position. During the movement of the push rod mechanism 20 between the fifth position and the sixth position, one end of the first elastic portion 510 abuts against the bottom portion 212, and the other end of the first elastic portion 510 abuts against the first movable contact piece 410. When the push rod mechanism 20 is in the sixth position, one end of the second elastic portion 520 abuts against the first movable contact piece 410, and the other end of the second elastic portion 520 abuts against the base 10.

Of course, in other embodiments, the first elastic portion 510 and the second elastic portion 520 can also be separate structures.

When the contact assembly 40 is in the fully open state, the second elastic portion 520 provides elastic force to the push rod mechanism 20, and this elastic force makes the push rod mechanism 20 tend to move toward the fifth position, so when it is necessary to make the push rod mechanism 20 move again (that is, the contact assembly 40 switches to the closed state) and energize the coil, since the push rod mechanism 20 has been subjected to the elastic force applied by the second elastic portion 520, the voltage for energizing the coil can be reduced, thereby reducing the action voltage and making the action voltage within the standard range. The standard range of the action voltage can be between 40% and 60% of the rated voltage, but is not limited to this.

In addition, by adjusting the magnitude of the elastic force applied by the second elastic portion 520, the magnitude of the action voltage of the relay can be flexibly adjusted. Specifically, when the elastic force provided by the second elastic portion 520 is increased, the action voltage of the relay decreases accordingly. When the elastic force provided by the second elastic portion 520 is decreased, the action voltage of the relay increases accordingly.

Furthermore, when the relay has the permanent magnet 340 (that is, the relay has a magnetic latching function), by adjusting the magnitude of the elastic force of the first elastic portion 510, the reset voltage of the relay can also be flexibly adjusted. Specifically, when the elastic force provided by the first elastic portion 510 is increased, the reset voltage of the relay decreases accordingly. When the elastic force provided by the first elastic portion 510 is decreased, the reset voltage of the relay increases accordingly.

Therefore, by adjusting the magnitude of the elastic force of the second elastic portion 520, the magnitude of the action voltage can be adjusted independently without affecting the reset voltage, and by adjusting the magnitude of the elastic force of the first elastic portion 510, the reset voltage of the relay can also be flexibly adjusted without affecting the action voltage, thereby making the action voltage and the reset voltage in a state of no voltage difference. At this time, only by magnetizing or demagnetizing the permanent magnet 340, the magnetic latching force can be increased or decreased, so the action voltage and the reset voltage can be adjusted synchronously without adjusting the dispersion of other components of the relay, reducing the accuracy requirements for other components.

It can be understood that adjusting the magnitude of the elastic force of the second elastic portion 520 can be achieved by changing the elastic modulus of the second elastic portion 520. For example, the method of changing the elastic modulus of the second elastic portion 520: the magnitude of the elastic force of the second elastic portion 520 can be adjusted by changing the deformation amount of the second elastic portion 520 in the uncompressed state, and can be adjusted by changing the width of the second elastic portion 520, but is not limited to this.

The actuation process of the push rod mechanism 210 driving the second movable contact piece 430 to contact or separate from the second static contact piece 440 is the same as that of the first contact assembly 40a, and thus will not be repeated here. Moreover, the second elastic component 500b has a structure similar to that of the first elastic component 500a and serves substantially the same function, which will also not be reiterated.

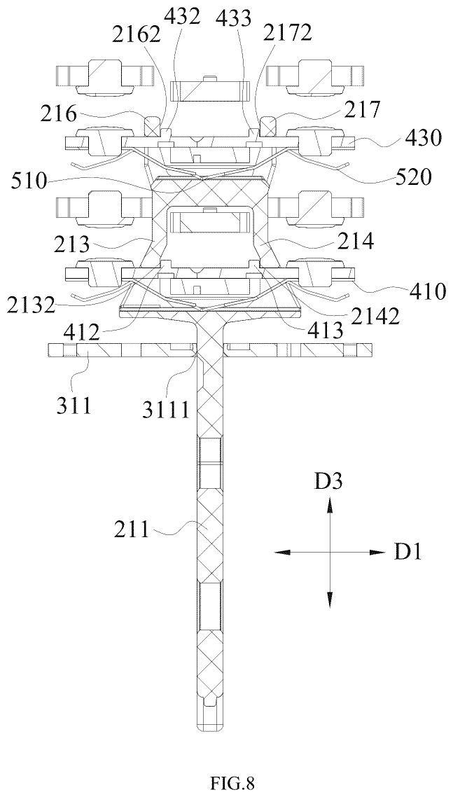

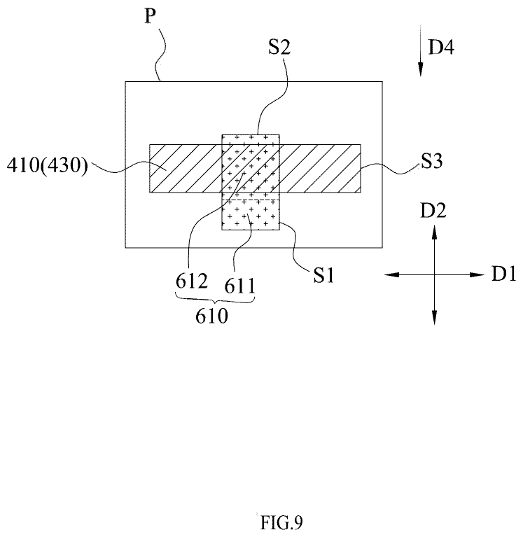

As shown in FIGS. 2 and 9, FIG. 9 illustrates the relative positions of the first orthographic projection, second orthographic projection, and third orthographic projection on the virtual plane P. The first magnetizer 610 includes a connection portion 611 and an overhang portion 612, with the connection portion 611 fixedly connected to the base 10. Here, a virtual plane P perpendicular to the movement direction D3 of the push rod mechanism 20 is defined. The connection portion 611 has a first orthographic projection S1 on the virtual plane P, the overhang portion 612 has a second orthographic projection S2 on the virtual plane P, and the movable contact pieces 410, 430 have a third orthographic projection S3 on the virtual plane P. The first orthographic projection S1 does not overlap with the third orthographic projection S3, while the second orthographic projection S2 at least partially overlaps with the third orthographic projection S3.

The overhang portion 612 refers to the part of the first magnetizer 610 that is suspended inside the relay and does not contact any other components of the relay.

Since the first orthographic projection S1 of the connection portion 611 of the first magnetizer 610 fixedly connected to the base 10 on the virtual plane P does not overlap with the third orthographic projection S2 of the movable contact pieces 410, 430 on the virtual plane P, this means the connection position of the first magnetizer 610 to the base 10 is not located above the movable contact pieces 410, 430. Thus, at least one first magnetizer 610 can be installed on the base 10, ensuring that each contact assembly 40 corresponds to one first magnetizer 610, thereby equipping each contact assembly 40 with an anti-short circuit structure.

As an example, the first magnetizer 610 may be a flat plate structure. Of course, in other embodiments, the first magnetizer 610 may also take other regular or irregular shapes.

As shown in FIG. 2, the connection portion 611 is inserted into the base 10 along an insertion direction D4, which is perpendicular to the movement direction D3 of the push rod mechanism 20.

In this embodiment, the connection portion 611 is inserted into the base 10 along the insertion direction D4, which is perpendicular to the movement direction D3 of the push rod mechanism 20. When the first magnetizer 610 is a plate-like structure, it is perpendicular to the movement direction D3 of the push rod mechanism 20. In other words, one end of the first magnetizer 610 with the connection portion 611 is connected to the base 10, while the other end with the overhang portion 612 extends in the opposite direction of the insertion direction D4 until the overhang portion 612 at least partially overlaps with the movable contact pieces 410, 430 along the movement direction D3 of the push rod mechanism 20.

Installing the first magnetizer 610 onto the base 10 via insertion simplifies the assembly process. Of course, in other embodiments, the first magnetizer 610 may also be connected to the base 10 via adhesive bonding, welding, or other methods.

Furthermore, the insertion direction D4 of the first magnetizer 610 is perpendicular to the length direction D1 of the movable contact pieces 410, 430. In other words, spatially, the first magnetizer 610 and the movable contact pieces 410, 430 are orthogonal.

It can be understood that when the movable contact pieces 410, 430 are energized, the magnetic conduction loop formed around them follows the width direction of the movable contact pieces 410, 430. Since the first magnetizer 610 is orthogonal to the movable contact pieces 410, 430, the magnetic conduction loop will follow the length direction D1 of the overhang portion 612 of the first magnetizer 610, magnetizing the vast majority of the overhang portion 612. This further enhances the attractive force between the first magnetizer 610 and the energized movable contact pieces 410, 430.

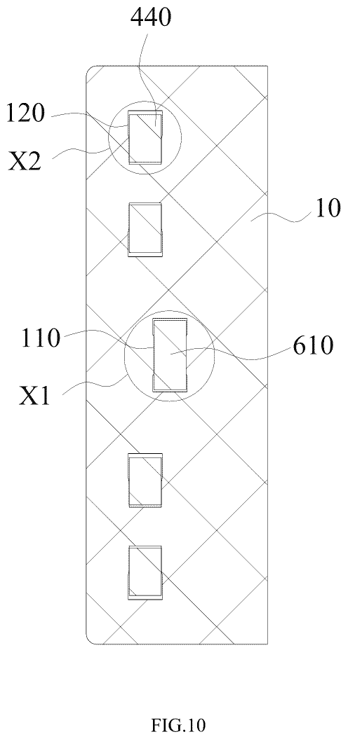

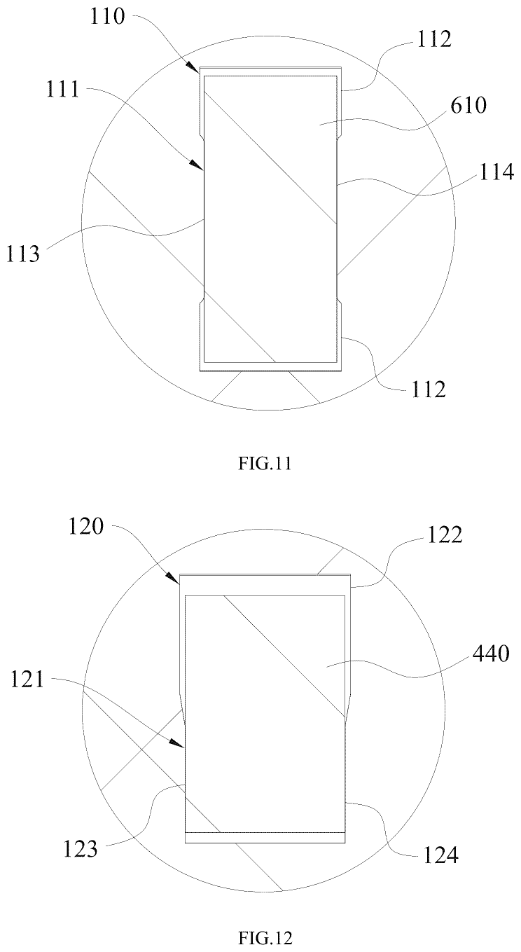

As shown in FIGS. 2, 10, and 11, FIG. 10 depicts the cross-sectional view along line D-D in FIG. 2, and FIG. 11 shows a partial enlarged view of area X1 in FIG. 10. The mounting part 11 includes a first mounting hole 110, which penetrates the inner and outer surfaces of the housing 1. The hole wall of the first mounting hole 110 has a first positioning wall structure 111 and a first gap wall structure 112. The first magnetizer 610 is inserted into the first mounting hole 110, with part of its outer wall surface abutting against the first positioning wall structure 111, while another part of its outer wall surface has a gap with the first gap wall structure 112, which is filled with sealant.

In this embodiment, the first mounting hole 110 is formed on the base 10 and penetrates its inner and bottom surfaces.

In this disclosed embodiment, the assembly process of the first magnetizer 610 and the base 10 is as follows: preliminary positioning is achieved via the first positioning wall structure 111 of the first mounting hole 110 on the base 10, and then sealant is injected into the gap between the first magnetizer 610 and the gap wall structure of the first mounting hole 110 to complete the sealed assembly. On one hand, part of the outer wall surface of the first magnetizer 610 abuts against the positioning wall structure 111, achieving preliminary positioning. On the other hand, the gap between another part of the outer wall surface and the gap wall structure 112 allows sealant to rise from the bottom surface of the base 10 to the inner surface via siphon effect until it fills the gap at the opening of the first mounting hole 110, enhancing both sealing and positioning strength. Additionally, the heat resistance of the sealant is superior than that of plastic materials, which improves the heat resistance of the relay product during welding. Compared to existing techniques, this embodiment eliminates one step of adhesive dispensing, effectively reducing costs and improving assembly efficiency.

As shown in FIG. 11, the first positioning wall structure 111 includes a first positioning wall 113 and a second positioning wall 114, which are arranged opposite each other along the movement direction D3 of the push rod mechanism 20. The first magnetizer 610 is restrained by the first positioning wall 113 and the second positioning wall 114, limiting its degrees of freedom along the movement direction D3.

It can be understood that the shapes of the first positioning wall 113 and the second positioning wall 114 are adapted to the outer contour of the first magnetizer 610. For example, if the cross-section of the first magnetizer 610 is rectangular, the first positioning wall 113 and the second positioning wall 114 may be flat. Of course, in other embodiments, if the cross-section of the connection portion 611 of the first magnetizer 610 is circular, the first positioning wall 113 and the second positioning wall 114 may be curved.

Part of the outer wall surface of the first magnetizer 610 is in interference fit with the first positioning wall structure 111. In this embodiment, the first magnetizer 610 is in interference fit with both the first positioning wall 113 and the second positioning wall 114. However, in other embodiments, a zero-clearance fit may also be used between part of the outer wall surface of the first magnetizer 610 and the first positioning wall structure 111.

As shown in FIG. 2, the static contact pieces 420, 440 are inserted into the base 10 along the insertion direction D4. Both the static contact pieces 420, 440 and the first magnetizer 610 are installed along the same insertion direction D4, allowing them to be assembled in the same step, saving time.

As shown in FIGS. 2, 10, and 12, FIG. 12 depicts a partial enlarged view of area X2 in FIG. 10. The base 10 also has a second mounting hole 120 penetrating its inner and bottom surfaces. The hole wall of the second mounting hole 120 has a second positioning wall structure 121 and a second gap wall structure 122. The static contact pieces 420, 440 are inserted into the second mounting hole 120, with part of their outer wall surfaces abutting against the second positioning wall structure 121, while another part has a gap with the second gap wall structure 122, which is filled with sealant.

The assembly process of the static contact pieces 420, 440 with the base 10 can refer to that of the first magnetizer 610 with the base 10. Specifically, the static contact pieces 420, 440 are preliminarily positioned via the second positioning wall structure 121 of the second mounting hole 120, and then sealant is injected into the gap between the static contact pieces 420, 440 and the second gap wall structure 122.

Thus, the static contact pieces 420, 440 and the first magnetizer 610 can be assembled with the base 10 in the same adhesive dispensing process, significantly improving assembly efficiency.

The second positioning wall structure 121 includes a third positioning wall 123 and a fourth positioning wall 124, which are arranged opposite each other along the movement direction D3 of the push rod mechanism 20. By abutting against the third positioning wall 123 and the fourth positioning wall 124 against the static contact pieces 420, 440, their degrees of freedom along the movement direction D3 are restricted.

It can be understood that the shapes of the third positioning wall 123 and the fourth positioning wall 124 are adapted to the outer contour of the lead-out terminals of the static contact pieces. For example, if the cross-section of the lead-out terminals is rectangular, the third positioning wall 123 and the fourth positioning wall 124 may be flat. Of course, in other embodiments, if the cross-section is circular, they may be curved.

Part of the outer wall surface of the static contact pieces 420, 440 is in interference fit with the second positioning wall structure 121. In this embodiment, they are in interference fit with both the third positioning wall 123 and the fourth positioning wall 124. However, in other embodiments, a zero-clearance fit may also be used between the outer wall surface of the static contact pieces 420, 440 and the second positioning wall structure 121.

As previously described, the first magnetizer 610 is preliminarily positioned by abutting against part of its outer wall surface against the first positioning wall structure 111, while the static contact pieces 420, 440 are positioned by abutting against the second positioning wall structure 121 (no adhesive is applied during preliminary positioning). Subsequently, sealant is injected from the bottom side of the base 10 into the gaps between the first magnetizer 610 and the first gap wall structure 112, as well as between the static contact pieces 420, 440 and the second gap wall structure 122. At the same time, sealant can also be applied to the gap between the cover and the base 10.

Thus, in this embodiment, sealant can be applied in a single direction to fill the gaps between the first magnetizer 610 and the base 10, between the static contact pieces 420, 440 and the base 10, and between the cover and the base 10, significantly improving efficiency. Additionally, gaps between the coil lead-out terminals and the base 10, as well as between the auxiliary contact lead-out terminals and the base 10, can also be sealed simultaneously.

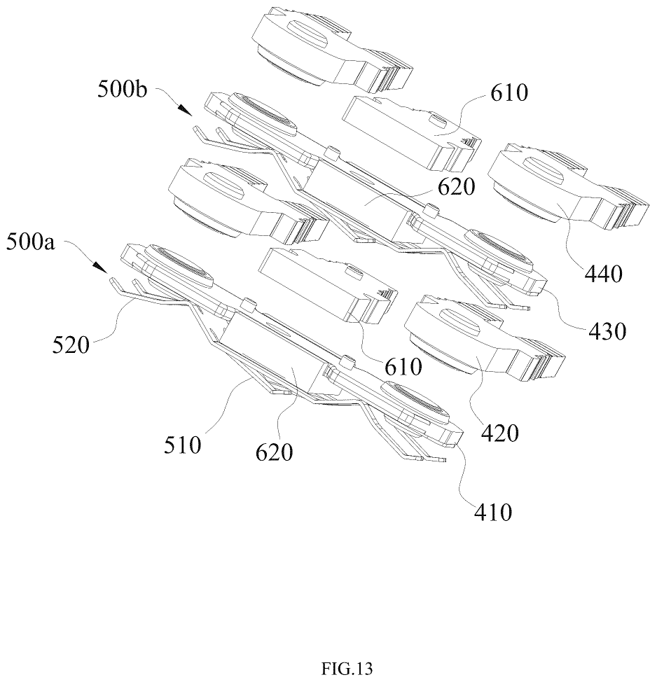

As shown in FIGS. 5, 6, and 13, the relay further includes a second magnetizer 620, which corresponds to the first magnetizer 610.

The second magnetizer 620 is fixedly connected to the side of the movable contact pieces 410, 430 facing away from the first magnetizer 610, forming a magnetic conduction loop between the first magnetizer 610 and the second magnetizer 620 along the width direction D2 of the movable contact pieces 410, 430.

It can be understood that the correspondence between the second magnetizer 620 and the first magnetizer 610 means they are equal in number and aligned in position. In this embodiment, there are two first magnetizers 610 and two second magnetizers 620, but this is not limiting.

When the movable contact pieces 410, 430 contact the static contact pieces 420, 440 at both ends, the second magnetizer 620 moves with the movable contact pieces 410, 430, approaching or contacting the first magnetizer 610, forming a magnetic loop around the movable contact pieces 410, 430. When a short-circuit current flows through the movable contact pieces 410, 430, an attractive force is generated between the first magnetizer 610 and the second magnetizer 620 in the direction of contact pressure. This attractive force combining with the contact pressure generates a greater contact pressure to counteract the electromagnetic repulsion caused by the short-circuit current, preventing the contacts from separating.

Notably, the first magnetizer 610 and the second magnetizer 620 are located at opposite sides of the movable contact pieces 410, 430. When current flows, this attractive force between the first magnetizer 610 and the second magnetizer 620 is direct electromagnetic attraction, which is stronger than that between the magnetized first magnetizer 610 and the movable contact pieces 410, 430, thus providing a more effective resistance against the electromagnetic repulsive force generated between the movable contact pieces 410, 430 and the static contact pieces 420, 440 due to short-circuit current, and more effectively resisting repulsion and enhancing short-circuit resistance.

The second magnetizer 620 may be riveted to the movable contact pieces 410, 430, but other methods are also possible.

The first magnetizer 610 and the second magnetizer 620 can be made of iron, cobalt, nickel, or their alloys.

The first magnetizer 610 may be linear, while the second magnetizer 620 is U-shaped, wrapping around the movable contact pieces 410, 430 along their width direction D2.

Referring back to FIG. 3, along the axial direction of the rod portion 211 (i.e., the movement direction D3 of the push rod mechanism 20), no part of the push rod 210 is accommodated between the second magnetizer 620 and its corresponding first magnetizer 610. This prevents the push rod 210 from interfering with the magnetic field, ensuring the relay's short-circuit resistance.

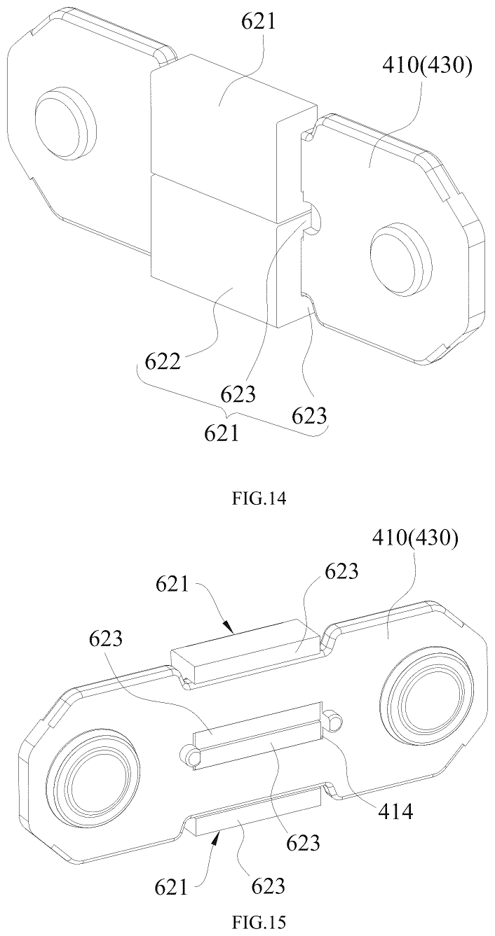

As shown in FIGS. 14 and 15, which depict two perspectives of the assembled movable contact pieces 410, 430 and second magnetizer 620 in the second embodiment, the differences from the first embodiment are as follows:

The second magnetizer 620 includes at least two sub-magnetizers 621, each U-shaped with a base portion 622 and two side portions 623. The movable contact pieces 410, 430 have at least one perforation 414. The sub-magnetizers 621 are connected to the side of the movable contact pieces 410, 430 facing away from the first magnetizer 610, with their side portions 623 passing through the perforation 414 to approach or contact the first magnetizer 610, forming at least two independent magnetic loops along the width direction D2 of the movable contact pieces 410, 430. By utilizing at least two independent magnetic circuits to increase the magnetic pole surfaces at the corresponding perforation 414 locations, an attractive force in the direction of contact pressure is generated when the movable contact pieces 410, 430 experience fault-induced high currents. This attractive force counteracts the electromagnetic repulsive force generated between the movable contact pieces 410, 430 and the static contact pieces 420, 440 due to the fault current.

The so-called two independent magnetic circuits refer to the fact that there is no mutual interference between the two magnetic circuits, that is, there is no mutual cancellation of magnetic flux.

In this embodiment, the movable contact pieces 410, 430 have one perforation 414 in the middle between the two movable contacts. The second magnetizer 620 includes two sub-magnetizers 621 sharing one first magnetizer 610, forming two loops.

The two U-shaped sub-magnetizers 621 are arranged side by side along the width direction D2, with one side portion 623 of each passing through the perforation 414.

In this embodiment, the top surfaces of the side portions 623 are substantially flush with the surface of the movable contact pieces 410, 430 facing the static contact pieces 420, 440.

In this embodiment of the disclosure, the two U-shaped sub-magnetizers 621 have a total of four side portions 623. The top surfaces of the four side portions 623 are in cooperation with the first magnetizer 610. Compared to having only one magnetic circuit (with only two magnetic pole surfaces), given that the structure of the second magnetizer 620 remains unchanged, this embodiment of the disclosure effectively adds two magnetic pole surfaces (the magnetic pole surfaces at the position of the perforation 414 are added). This enhances the magnetic efficiency, increases the attractive force, and significantly improves the anti-short circuit capability.

A gap exists between the two side portions 623 in the same perforation 414, preventing magnetic flux cancellation.

Of course, in other embodiments, there may be three or more sub-magnetizers 621.

On the one hand, when the push rod drives the movable contact piece to move, the push rod forms two pulling force points with the movable contact piece through the first side portion and the second side portion, and the two pulling force points are arranged along the length direction of the movable contact piece, so that the movable contact piece moves more stably. On the other hand, in the movement direction of the push rod mechanism, no part of the push rod is accommodated between the magnetic conduction area of the movable contact piece and the first magnetic conductor, thereby preventing the push rod from affecting the magnetic field strength between the movable contact piece and the first magnetic conductor and ensuring the anti-short circuit capability.

It is understood that the various embodiments/implementations disclosed herein can be combined without contradiction, and examples are not repeated here.

Additionally, aiming at the problems in prior art where the connection structure between the push rod and the movable contact piece is insufficiently stable, causing unsteady movement of the movable contact piece during contact separation, this embodiment of the disclosure provides a relay to solve the problem of unstable movement of the movable contact piece in existing technologies.

The relay in this embodiment includes a first contact assembly, and a push rod. The first contact assembly includes a first static contact piece and a first movable contact piece. The push rod drives the first movable contact piece to move to contact or separate from the first static contact piece. The push rod includes a rod portion, a bottom portion, a first side portion, and a second side portion. The bottom portion connects to an end of the rod portion in an axial. The first side portion and the second side portion both connect to the bottom portion and are arranged opposite each other along a length direction of the first movable contact piece. The first side portion has a first through hole. The second side portion has a second through hole. The first movable contact piece passes through the first through hole and the second through hole. Along the axial direction of the rod portion, the first movable contact piece is movable between a first position and a second position relative to the first through hole and the second through hole. In the first position, the first movable contact piece abuts against the hole walls of both the first through hole and the second through hole.

According to some embodiments of the disclosure, the relay further includes a first elastic component, the first elastic component is arranged between the first movable contact piece and the bottom portion to apply an elastic force to the first movable contact piece toward the first position.

According to some embodiments of the disclosure, both ends of the first movable contact piece along the length direction are provided with first movable contacts. One first movable contact is located at a side of the first side portion facing away from the second side portion, and the other first movable contact is located at a side of the second side portion facing away from the first side portion.

According to some embodiments of the disclosure, one side of the first movable contact piece protrudes with a first positioning portion and a second positioning portion. The first positioning portion corresponds to the position of the first side portion. The second positioning portion corresponds to the position of the second side portion.

Along the length direction of the first movable contact piece, the first movable contact piece is positioned at a predetermined location on the push rod through the first positioning portion and the second positioning portion.

According to some embodiments of the disclosure, the first side portion has a first stopping surface facing the second side portion. The second side portion has a second stopping surface facing the first side portion.

The first positioning portion abuts against the first stopping surface. The second positioning portion abuts against the second stopping surface.

According to some embodiments of the disclosure, the first positioning portion and the second positioning portion protrude from a surface of the first movable contact piece facing the first static contact piece.

According to some embodiments of the disclosure, the relay further includes a second contact assembly and a second elastic component. The second contact assembly includes a second movable contact piece and a second static contact piece.

The push rod further includes a spacing portion, a third side portion, and a fourth side portion. The third side portion connects to an end of the first side portion facing away from the bottom portion. The fourth side portion connects to an end of the second side portion facing away from the bottom portion. The spacing portion is arranged between the third side portion and the fourth side portion. The third side portion has a third through hole. The fourth side portion has a fourth through hole. The second movable contact piece passes through the third through hole and the fourth through hole. Along the axial direction of the rod portion, the second movable contact piece is movable between a third position and a fourth position relative to the third through hole and the fourth through hole. In the third position, the second movable contact piece abuts against the hole walls of both the third through hole and the fourth through hole.

The second elastic component is arranged between the second movable contact piece and the spacing portion to apply an elastic force to the second movable contact piece toward the third position.

According to some embodiments of the disclosure, the bottom portion, the spacing portion, the first side portion, and the second side portion together enclose a chamber. The first through hole and the second through hole both communicate with the chamber. The third through hole and the fourth through hole do not communicate with the chamber.

According to some embodiments of the disclosure, both ends of the second movable contact piece along the length direction are provided with second movable contacts. One second movable contact is located at a side of the third side portion facing away from the fourth side portion, and another second movable contact is located at a side of the fourth side portion facing away from the third side portion.

According to some embodiments of the disclosure, one side of the second movable contact piece protrudes with a third positioning portion and a fourth positioning portion. The third positioning portion corresponds to the position of the third side portion. The fourth positioning portion corresponds to the position of the fourth side portion.

Along the length direction of the second movable contact piece, the second movable contact piece is positioned at a predetermined location on the push rod through the third positioning portion and the fourth positioning portion.

According to some embodiments of the disclosure, the third side portion has a third stopping surface facing the fourth side portion. The fourth side portion has a fourth stopping surface facing the third side portion.

The third positioning portion abuts against the third stopping surface. The fourth positioning portion abuts against the fourth stopping surface.

According to some embodiments of the disclosure, the third positioning portion and the fourth positioning portion protrude from a surface of the second movable contact piece facing the second static contact piece.

According to some embodiments of the disclosure, the rod portion, the bottom portion, the first side portion, and the second side portion are of integral structure.

At least one embodiment of the above utility model has the following advantages or beneficial effects: In the relay of this embodiment, the position where the hole wall of the first through hole abuts against the first movable contact piece serves as one force application point, and the position where the hole wall of the second through hole abuts against the first movable contact piece serves as another force application point. By arranging two force application points along the length direction of the first movable contact piece, the force application area on the first movable contact piece from the push rod is larger, making the movement of the first movable contact piece driven by the push rod more stable.

The embodiments of the disclosure are described in detail below with reference to the drawings.

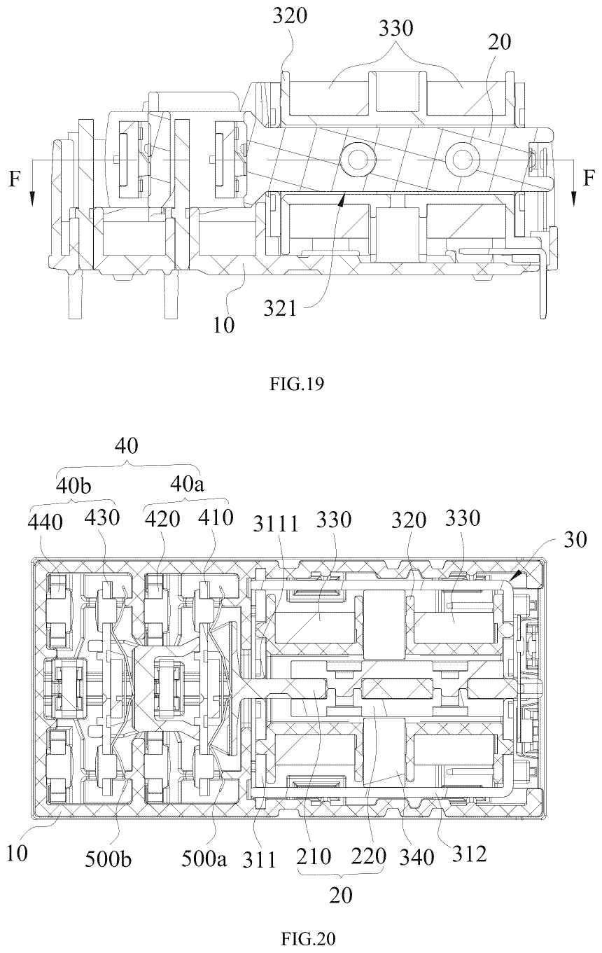

As shown in FIG. 18 to FIG. 20, FIG. 18 shows a top view of the relay in this embodiment with the upper cover omitted, FIG. 19 shows a cross-sectional view along E-E in FIG. 18, and FIG. 20 shows a cross-sectional view along F-F in FIG. 19. The relay in this embodiment includes a base 10, a push rod mechanism 20, a magnetic circuit mechanism 30, and a contact assembly 40. The push rod mechanism 20, the magnetic circuit mechanism 30, and the contact assembly 40 are arranged on the base 10. The magnetic circuit mechanism 30 controls the contact or separation of the contact assembly 40 through the push rod mechanism 20.

The magnetic circuit mechanism 30 includes a yoke structure 310, a bobbin 320, and a coil 330. The yoke structure 310 forms a chamber. The bobbin 320 and the coil 330 are both arranged in the chamber of the yoke structure 310. The coil 330 is wound around the periphery of the bobbin 320 to form a magnetic control circuit. The bobbin 320 has a center hole 321 in the contact-separation direction of the contact assembly 40 for one end of the push rod mechanism 20 to pass through.

As an example, the yoke structure 310 includes a yoke plate 311 and a U-shaped yoke 312. The yoke plate 311 and the U-shaped yoke 312 are connected to form a ring together. The yoke plate 311 has a through hole 3111 for the push rod mechanism 20 to pass through.

Certainly, in other embodiments, the yoke structure 310 may also include a cylindrical yoke and the yoke plate 311. The cylindrical yoke and the yoke plate 311 are connected to form a ring together.

The magnetic circuit mechanism 30 further includes two permanent magnets 340. The two permanent magnets 340 are arranged on the bobbin 320 and located at both sides of the movement direction of the push rod mechanism 20. The two permanent magnets 340 form a magnetic latching circuit structure, which helps reduce power consumption, extend service life, and improve stability.

Certainly, in other embodiments, the permanent magnets 340 may be omitted.

As shown in FIG. 20, the push rod mechanism 20 is movable relative to the base 10 between a fifth position and a sixth position. When the push rod mechanism 20 is in the fifth position, the contact assembly 40 is in a fully closed state. When the push rod mechanism 20 is in the sixth position, the contact assembly 40 is in a fully open state. The push rod mechanism 20 includes a push rod 210 and an iron core 220. The iron core 220 connects to the push rod 210. Under the action of the magnetic control circuit formed by the coil 330, the iron core 220 can move along the contact-separation direction, thereby driving the push rod 210 to move and controlling the contact or separation of the contact assembly 40.

It should be noted that the fully closed state of the contact assembly 40 refers to the state where the movable contact piece and the static contact piece of the contact assembly 40 are in contact and overtravel is completed. The fully open state of the contact assembly 40 refers to the state where the movable contact piece and the static contact piece of the contact assembly 40 are separated and contact gap is maximum.

Referring to FIG. 18 to FIG. 20, the contact assembly 40 includes movable contact pieces 410, 430 and static contact pieces 420, 440. The static contact pieces 420, 440 are fixedly mounted on the base 10. The movable contact pieces 410, 430 are mounted on the push rod mechanism 20 and move with the push rod mechanism 20.

In this embodiment, there are two sets of contact assemblies: a first contact assembly 40a and a second contact assembly 40b. The first contact assembly 40a and the second contact assembly 40b are arranged along the movement direction of the push rod mechanism 20. The first contact assembly 40a is closer to the magnetic circuit mechanism 30, while the second contact assembly 40b is farther from the magnetic circuit mechanism 30.

The first contact assembly 40a includes a first movable contact piece 410 and two first static contact pieces 420. The second contact assembly 40b includes a second movable contact piece 430 and two second static contact pieces 440. The two ends of the first movable contact piece 410 can respectively contact or separate from the two first static contact pieces 420. The two ends of the second movable contact piece 430 can respectively contact or separate from the two second static contact pieces 440.

Certainly, in other embodiments, the contact assembly 40 may include one set or other quantities.

The two ends of the movable contact pieces 410, 430 along the length direction serve as movable contacts. The movable contacts may protrude from other parts of the movable contact pieces 410, 430 or be flush with other parts. The parts of the static contact pieces 420, 440 that contact the movable contacts serve as static contacts. The static contacts may protrude from other parts of the static contact pieces 420, 440 or be flush with other parts.

As an example, the first movable contact piece 410 includes a first movable piece body 416 and a first movable contact 411. The first movable contact 411 and the first movable piece body 416 are separate structures. The first movable contact 411 and the first movable piece body 416 may be connected by riveting, but are not limited to this. The first static contact piece 420 includes a first static piece body 421 and a first static contact 422. The first static contact 422 and the first static piece body 421 are separate structures. The first static contact 422 and the first static piece body 421 may be connected by riveting, but are not limited to this.

The second movable contact piece 430 includes a second movable piece body 434 and a second movable contact 431. The second movable contact 431 and the second movable piece body 434 are separate structures. The second movable contact 431 and the second movable piece body 434 may be connected by riveting, but are not limited to this. The second static contact piece 440 includes a second static piece body 441 and a second static contact 442. The second static contact 442 and the second static piece body 441 are separate structures. The second static contact 442 and the second static piece body 441 may be connected by riveting, but are not limited to this.

Certainly, in another embodiment, the first movable contact 411 and the first movable piece body 416 may be an integral structure; the first static contact 422 and the first static piece body 421 may be an integral structure; the second movable contact 431 and the second movable piece body 434 may be an integral structure; the second static contact 442 and the second static piece body 441 may be an integral structure.

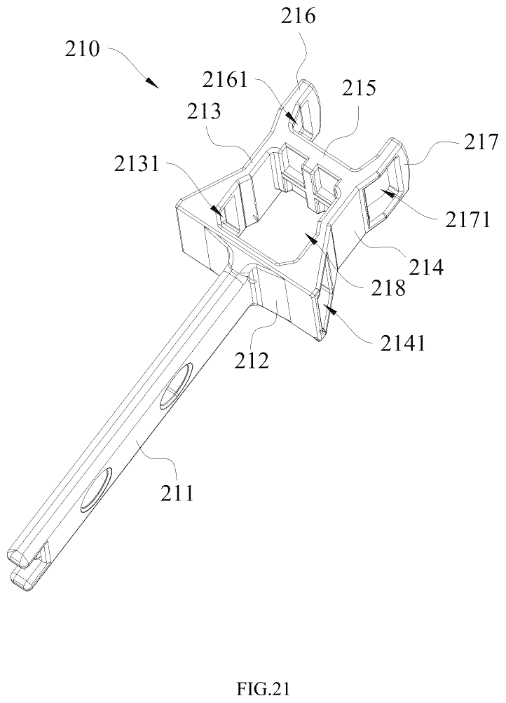

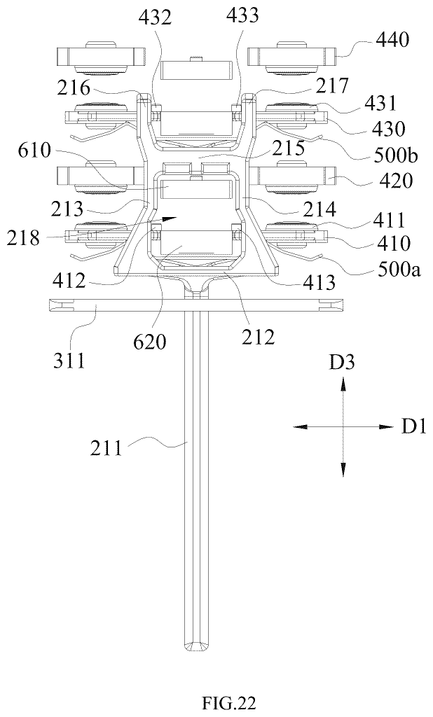

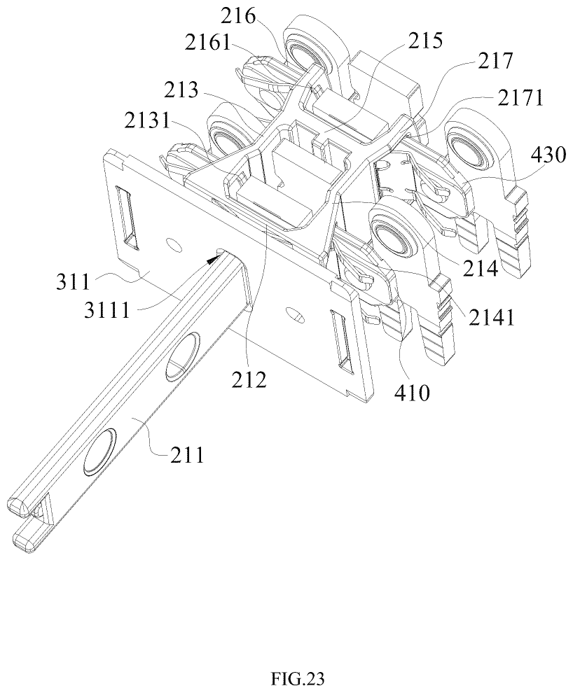

As shown in FIG. 21 to FIG. 23, FIG. 21 shows a schematic diagram of the push rod 210. FIG. 22 shows a front view of the assembled push rod 210, contact assembly 40, and yoke plate 311. FIG. 23 shows a three-dimensional view of the assembled push rod 210, contact assembly 40, and yoke plate 311. The push rod 210 drives the first movable contact piece 410 to move to contact or separate from the first static contact piece 420. The push rod 210 includes a rod portion 211, a bottom portion 212, a first side portion 213, and a second side portion 214. The rod portion 211 is movably inserted through the through hole 3111 of the yoke plate 311. The iron core 220 connects to the rod portion 211. The bottom portion 212 connects to one axial end of the rod portion 211. The first side portion 213 and the second side portion 214 both connect to the bottom portion 212 and are arranged opposite each other along the length direction D1 of the first movable contact piece 410. The first side portion 213 has a first through hole 2131. The second side portion 214 has a second through hole 2141. The first movable contact piece 410 passes through the first through hole 2131 and the second through hole 2141. Along the axial direction D3 (i.e., the movement direction of the push rod 210), the first movable contact piece 410 is movable between a first position and a second position relative to the first through hole 2131 and the second through hole 2141. In the first position, the first movable contact piece 410 abuts against the hole walls of the first through hole 2131 and the second through hole 2141 (as shown in FIG. 22 and FIG. 23).

The relay further includes an elastic assembly. The elastic assembly includes a first elastic component 500a and a second elastic component 500b. The first elastic component 500a is arranged between the first movable contact piece 410 and the bottom portion 212 to apply an elastic force to the first movable contact piece 410 toward the first position.

During the closing process of the first contact assembly 40a of the relay, the push rod 210 drives the first movable contact piece 410 to move toward the first static contact piece 420. Before the first movable contact piece 410 contacts the first static contact piece 420, under the action of the first elastic component 500a, the first movable contact piece 410 abuts against the hole walls of the first through hole 2131 and the second through hole 2141 and is in the first position. After the first movable contact piece 410 contacts the first static contact piece 420, since the first static contact piece 420 is fixedly mounted on the base 10, the first movable contact piece 410 is blocked by the first static contact piece 420 and cannot continue to move. At this time, the push rod 210 continues to move, and the first elastic component 500a is gradually compressed until overtravel is completed. At this time, the first movable contact piece 410 is in the second position relative to the first through hole 2131 and the second through hole 2141.

During the separation process of the first contact assembly 40a of the relay, the movement of the push rod 210 away from the first static contact piece 420 can be divided into two stages: In the first stage, the push rod 210 moves while the first movable contact piece 410 does not move with the push rod 210. In the first stage, the first movable contact piece 410 moves from the second position to the first position relative to the first through hole 2131 and the second through hole 2141. At the beginning of the second stage, the first movable contact piece 410 has moved to the first position relative to the first through hole 2131 and the second through hole 2141, and the first movable contact piece 410 abuts against the hole walls of the first through hole 2131 and the second through hole 2141. Afterward, the movement of the push rod 210 drives the first movable contact piece 410 to move, causing the first movable contact piece 410 to separate from the first static contact piece 420. In the second stage, when the push rod 210 drives the first movable contact piece 410 to move, since the first movable contact piece 410 abuts against the hole walls of the first through hole 2131 and the second through hole 2141, it is equivalent to the push rod 210 acting on the first movable contact piece 410 through the first side portion 213 and the second side portion 214 to separate the first movable contact piece 410 from the first static contact piece 420.

It can be seen that the position where the hole wall of the first through hole 2131 abuts against the first movable contact piece 410 serves as one force application point, and the position where the hole wall of the second through hole 2141 abuts against the first movable contact piece 410 serves as another force application point. By arranging two force application points along the length direction D1 of the first movable contact piece 410, the force application area of the push rod 210 on the first movable contact piece 410 is larger, making the movement of the first movable contact piece 410 driven by the push rod 210 more stable.

As shown in FIG. 22, both ends of the first movable contact piece 410 along the length direction D1 are provided with first movable contacts 411. One first movable contact 411 is located at a side of the first side portion 213 facing away from the second side portion 214, and the other first movable contact 411 is located at a side of the second side portion 214 facing away from the first side portion 213. That is, the two force application points where the first side portion 213 and the second side portion 214 act on the first movable contact piece 410 are located between the two first movable contacts 411 of the first movable contact piece 410.

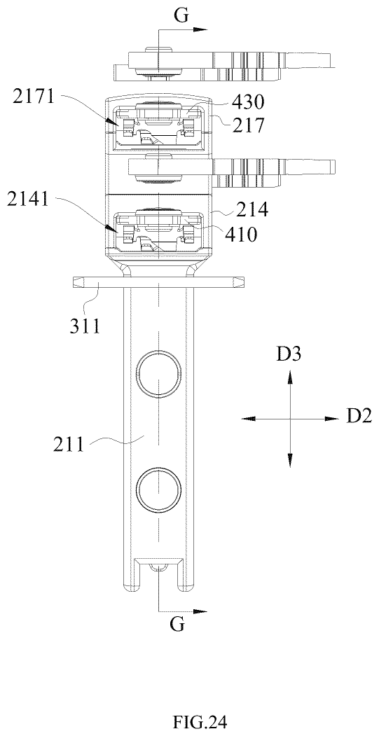

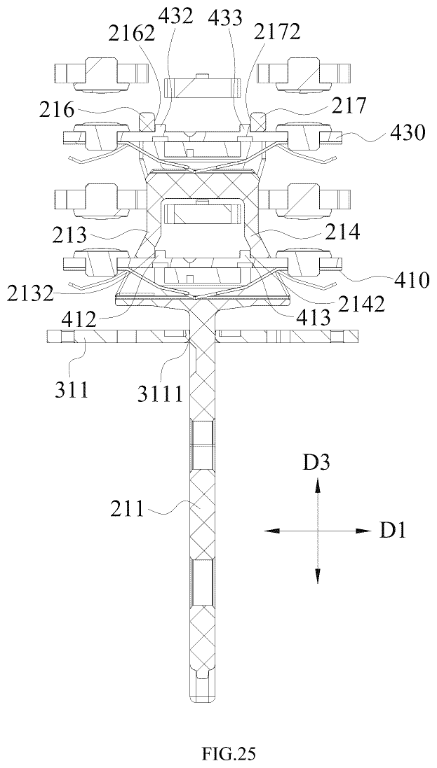

As shown in FIG. 24 and FIG. 25, FIG. 24 shows a side view of FIG. 22. FIG. 25 shows a cross-sectional view along G-G in FIG. 24. One side of the first movable contact piece 410 protrudes with a first positioning portion 412 and a second positioning portion 413. The first positioning portion 412 corresponds to the position of the first side portion 213. The second positioning portion 413 corresponds to the position of the second side portion 214. Along the length direction D1 of the first movable contact piece 410, the first movable contact piece 410 is positioned at a predetermined location on the push rod 210 through the first positioning portion 412 and the second positioning portion 413.

In this embodiment, by providing the first positioning portion 412 and the second positioning portion 413 on the first movable contact piece 410, the first movable contact piece 410 can be installed at the predetermined location on the push rod 210 along its length direction D1, avoiding relative shaking between the first movable contact piece 410 and the first side portion 213 and second side portion 214, and further improving the stability of the first movable contact piece 410 during movement.

Specifically, along the axial direction D3 of the rod portion 211, the first elastic component 500a is arranged between the bottom portion 212 and the first movable contact piece 410. The first movable contact piece 410 is always subjected to the elastic force of the first elastic component 500a, causing the first movable contact piece 410 to contact the hole walls of the first through hole 2131 and the second through hole 2141. Therefore, along the axial direction D3 of the rod portion 211, there is no relative shaking between the first movable contact piece 410 and the push rod 210.

Along the length direction D1 of the first movable contact piece 410, through the arrangement of the first positioning portion 412 and the second positioning portion 413, there is also no relative shaking between the first movable contact piece 410 and the push rod 210.

Along the width direction D2 of the first movable contact piece 410, the dimensions of the first through hole 2131 and the second through hole 2141 can be designed to match the width of the first movable contact piece 410, preventing excessive gaps between the first movable contact piece 410 and the hole walls of the first through hole 2131 and second through hole 2141.

Referring to FIG. 25, the first side portion 213 has a first stopping surface 2132 facing the second side portion 214, and the second side portion 214 has a second stopping surface 2142 facing the first side portion 213. The first positioning portion 412 abuts against the first stopping surface 2132, and the second positioning portion 413 abuts against the second stopping surface 2142.

Certainly, in other embodiments, gaps may exist between the first positioning portion 412 and the first stopping surface 2132, and between the second positioning portion 413 and the second stopping surface 2142. These gaps should not be too large to facilitate installation of the first positioning portion 412 and second positioning portion 413 between the first side portion 213 and second side portion 214 while preventing relative shaking along the length direction D1 of the first movable contact piece 410.

The first positioning portion 412 and second positioning portion 413 protrude from the surface of the first movable contact piece 410 facing the first static contact piece 420.

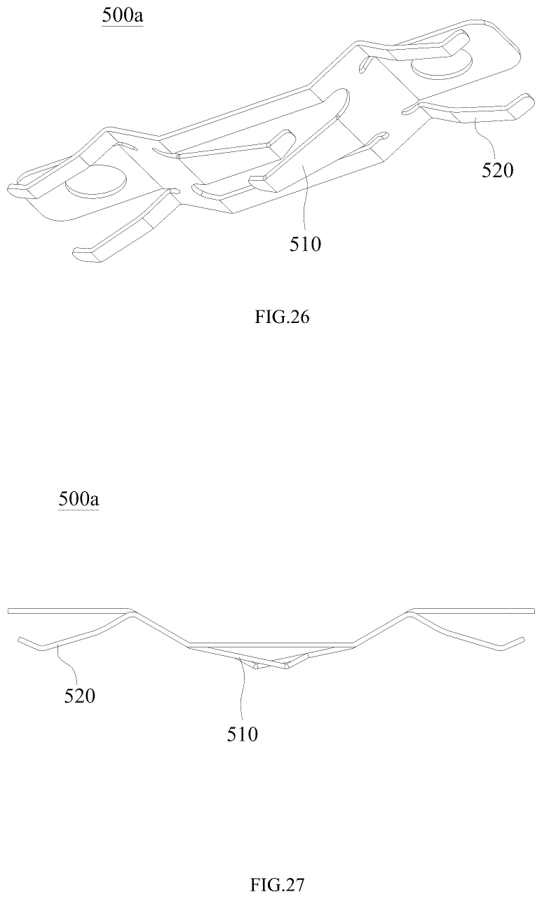

As shown in FIG. 20, FIG. 22, FIG. 26 and FIG. 27, the first elastic component 500a includes a first elastic portion 510 and a second elastic portion 520, and the first elastic portion 510 and the second elastic portion 520 form integral structure. The first movable contact piece 410 is mounted on the push rod 210 of the push rod mechanism 20 through the first elastic portion 510. The first elastic portion 510 provides overtravel contact pressure when the push rod mechanism 20 is in the fifth position, while the second elastic portion 520 provides elastic force toward the fifth position when the push rod mechanism 20 is in the sixth position. During movement between the fifth and sixth positions, one end of the first elastic portion 510 abuts against the bottom portion 212 while the other end abuts against the first movable contact piece 410. In the sixth position, one end of the second elastic portion 520 abuts against the first movable contact piece 410 while the other end abuts against the base 10.

Of course, in other embodiments, the first elastic portion 510 and second elastic portion 520 may alternatively be separate structures.

When the contact assembly 40 is in the fully open state, the second elastic portion 520 provides elastic force to the push rod mechanism 20, and this elastic force makes the push rod mechanism 20 tend to move toward the fifth position, so when it is necessary to make the push rod mechanism 20 move again (that is, the contact assembly 40 switches to the closed state) and energize the coil, since the push rod mechanism 20 has been subjected to the elastic force applied by the second elastic portion 520, the voltage for energizing the coil can be reduced, thereby reducing the action voltage and making the action voltage within the standard range. The standard range of the action voltage can be between 40% and 60% of the rated voltage, but is not limited to this.

In addition, by adjusting the magnitude of the elastic force applied by the second elastic portion 520, the magnitude of the action voltage of the relay can be flexibly adjusted. Specifically, when the elastic force provided by the second elastic portion 520 is increased, the action voltage of the relay decreases accordingly. When the elastic force provided by the second elastic portion 520 is decreased, the action voltage of the relay increases accordingly.

Furthermore, when the relay has the permanent magnet 340 (that is, the relay has a magnetic latching function), by adjusting the magnitude of the elastic force of the first elastic portion 510, the reset voltage of the relay can also be flexibly adjusted. Specifically, when the elastic force provided by the first elastic portion 510 is increased, the reset voltage of the relay decreases accordingly. When the elastic force provided by the first elastic portion 510 is decreased, the reset voltage of the relay increases accordingly.

Therefore, by adjusting the magnitude of the elastic force of the second elastic portion 520, the magnitude of the action voltage can be adjusted independently without affecting the reset voltage, and by adjusting the magnitude of the elastic force of the first elastic portion 510, the reset voltage of the relay can also be flexibly adjusted without affecting the action voltage, thereby making the action voltage and the reset voltage in a state of no voltage difference. At this time, only by magnetizing or demagnetizing the permanent magnet 340, the magnetic latching force can be increased or decreased, so the action voltage and the reset voltage can be adjusted synchronously without adjusting the dispersion of other components of the relay, reducing the accuracy requirements for other components.

It can be understood that adjusting the magnitude of the elastic force of the second elastic portion 520 can be achieved by changing the elastic modulus of the second elastic portion 520. For example, the method of changing the elastic modulus of the second elastic portion 520: the magnitude of the elastic force of the second elastic portion 520 can be adjusted by changing the deformation amount of the second elastic portion 520 in the uncompressed state, and can be adjusted by changing the width of the second elastic portion 520, but is not limited to this.

As shown in FIG. 21-FIG. 23, the second contact assembly 40b and the first contact assembly 40a are arranged along the axial direction D3 of the rod portion 211. The push rod 210 further includes a spacing portion 215, a third side portion 216 and a fourth side portion 217. The third side portion 216 connects to one end of the first side portion 213 facing away from the bottom portion 212, while the fourth side portion 217 connects to one end of the second side portion 214 facing away from the bottom portion 212. The spacing portion 215 is positioned between the third side portion 216 and the fourth side portion 217.

The third side portion 216 has a third through hole 2161 and the fourth side portion 217 has a fourth through hole 2171. The second movable contact piece 430 passes through the third through hole 2161 and the fourth through hole 2171. The third through hole 2161 is located at one side of the spacing portion 215 along the axial direction of the rod portion 211, and the first through hole 2131 is located at the other side of the spacing portion 215 along the axial direction of the rod portion 211. The fourth through hole 2171 is located at one side of the spacing portion 215 along the axial direction of the rod portion 211, and the second through hole 2141 is located at the other side of the spacing portion 215 along the axial direction of the rod portion 211. Along the axial direction of the rod portion 211 D3, the second movable contact piece 430 is movable between a third position and a fourth position relative to the third through hole 2161 and the fourth through hole 2171. In the third position, the second movable contact piece 430 abuts against the hole walls of the third through hole 2161 and the fourth through hole 2171 respectively.

The second elastic component 500b is arranged between the second movable contact piece 430 and the spacing portion 215, and is used to apply an elastic force to the second movable contact piece 430 to move toward the third position.

The action process of the push rod 210 driving the second movable contact piece 430 to contact or separate from the second static contact piece 440 is the same as that of the first contact assembly 40a, which will not be repeated here. Moreover, the second elastic component 500b has a similar structure to the first elastic component 500a and plays basically the same role, which will not be repeated here.

The hole wall of the third through hole 2161 abutting against the second movable contact piece 430 is equivalent to one force application point, and the hole wall of the fourth through hole 2171 abutting against the second movable contact piece 430 is equivalent to another force application point. By setting two force application points arranged along the length direction D1 of the second movable contact piece 430, the second movable contact piece 430 has a larger force-bearing area for the pulling force from the push rod 210, making the movement of the second movable contact piece 430 driven by the push rod 210 more stable.

As shown in FIG. 21, the bottom portion 212, the spacing portion 215, the first side portion 213, and the second side portion 214 enclose a chamber 218. Both the first through hole 2131 and the second through hole 2141 are communicated to the chamber 218, while the third through hole 2161 and the fourth through hole 2171 are not communicated to the chamber 218. The chamber 218 can be used to accommodate an anti-short circuit structure. As shown in FIG. 22, the anti-short circuit structure may include a first magnetizer 610 and a second magnetizer 620, both of which are arranged in the chamber 218. The first magnetizer 610 is fixedly connected to the base 10, and the second magnetizer 620 is fixedly connected to the first movable contact piece 410 and is arranged at the side of the first movable contact piece 410 facing away from the first magnetizer 610. A magnetic conduction loop is formed between the first magnetizer 610 and the second magnetizer 620. When a short-circuit current passes through the first movable contact piece 410, an attractive force is generated between the first magnetizer 610 and the second magnetizer 620 along the direction of contact pressure. This attractive force combines with the contact pressure to produce a greater contact pressure, which can resist the electromagnetic repulsion force generated by the short-circuit current between the movable contact of the first movable contact piece 410 and the static contact of the first static contact piece 420, ensuring that the movable contact of the first movable contact piece 410 and the static contact of the first static contact piece 420 do not separate.

As shown in FIG. 22, both ends of the second movable contact piece 430 along the length direction D1 are provided with second movable contacts 431. One second movable contact 431 is located at a side of the third side portion 216 facing away from the fourth side portion 217, and the other second movable contact 431 is located at a side of the fourth side portion 217 facing away from the third side portion 216. This means the two force application points where the third side portion 216 and fourth side portion 217 act on the second movable contact piece 430 are located between the two second movable contacts 431 of the second movable contact piece 430.

Referring to FIG. 24 and FIG. 25, one side of the second movable contact piece 430 protrudes with a third positioning portion 432 and a fourth positioning portion 433. The third positioning portion 432 corresponds to the position of the third side portion 216, and the fourth positioning portion 433 corresponds to the position of the fourth side portion 217. Along the length direction D1 of the second movable contact piece 430, the second movable contact piece 430 is positioned at a predetermined location on the push rod 210 through the third positioning portion 432 and fourth positioning portion 433.

In this embodiment, by providing the third positioning portion 432 and fourth positioning portion 433 on the second movable contact piece 430, the second movable contact piece 430 can be installed at the predetermined position along its length direction D1 on the push rod 210, preventing relative shaking between the second movable contact piece 430 and the third side portion 216/fourth side portion 217, thereby further improving the stability of the second movable contact piece 430 during movement.

Specifically, along the axial direction D3 of the rod portion 211, the second elastic component 500b is arranged between the spacing portion 215 and the second movable contact piece 430. The second movable contact piece 430 is always subjected to the elastic force of the second elastic component 500b, causing it to abut the hole walls of the third through hole 2161 and fourth through hole 2171. Therefore, along the axial direction D3 of the rod portion 211, there is no relative shaking between the second movable contact piece 430 and the push rod 210.

Along the length direction D1 of the second movable contact piece 430, through the arrangement of the third positioning portion 432 and fourth positioning portion 433, there is also no relative shaking between the second movable contact piece 430 and the push rod 210.

Along the width direction D2 of the second movable contact piece 430, the dimensions of the third through hole 2161 and fourth through hole 2171 can be designed to match the width of the second movable contact piece 430, preventing excessive gaps between the second movable contact piece 430 and the hole walls of the third through hole 2161 and fourth through hole 2171.

Continuing to refer to FIG. 25, the third side portion 216 has a third stopping surface 2162 facing the fourth side portion 217, and the fourth side portion 217 has a fourth stopping surface 2172 facing the third side portion 216. The third positioning portion 432 abuts against the third stopping surface 2162, and the fourth positioning portion 433 abuts against the fourth stopping surface 2172.

Certainly, in other embodiments, gaps may exist between the third positioning portion 432 and the third stopping surface 2162, and between the fourth positioning portion 433 and the fourth stopping surface 2172.

The third positioning portion 432 and fourth positioning portion 433 protrude from the surface of the second movable contact piece 430 facing the second static contact piece 440.

The rod portion 211, bottom portion 212, first side portion 213, second side portion 214, spacing portion 215, third side portion 216 and fourth side portion 217 of the push rod 210 are of integral structure.

As an example, the push rod 210 may be made of plastic through injection molding.

The first elastic component 500a and second elastic component 500b may be spring pieces, but are not limited to this.

It should be understood that the various embodiments/implementations provided in this disclosure can be combined without contradiction, and examples are not repeated here.

In some relays, auxiliary contact assemblies are installed to monitor the contact status of main contacts. Since the monitoring current flowing through auxiliary contact assemblies is very small (milliampere level), auxiliary contact assemblies have relatively small sizes.

In prior art, an auxiliary contact assembly include an auxiliary movable contact and an auxiliary static contact, typically using a small silver contact riveted on the auxiliary movable contact as the movable contact. However, as mentioned, the small size of auxiliary contact assemblies makes silver contact installation inconvenient.

This embodiment provides a relay and its auxiliary contact assembly to solve the inconvenient assembly problem of auxiliary contacts in prior art.

The auxiliary contact assembly in this embodiment, applied to relays, includes an auxiliary movable contact piece and an auxiliary static contact piece. The auxiliary movable contact piece includes a movable contact terminal. The auxiliary static contact piece has a needle-shaped structure. Along an axial direction of the needle-shaped structure, the auxiliary static contact piece includes a static contact lead-out terminal and a static contact terminal, wherein a side surface of the static contact terminal is configured to contact or separate from the movable contact terminal.

According to some embodiments, the auxiliary movable contact piece further includes a movable contact lead-out terminal.

According to some embodiments, the movable contact terminal includes: a base body; and a protrusion protruding from the surface of the base body facing the static contact terminal, for contacting or separating from the side surface of the static contact terminal.

According to some embodiments, the base body includes a first elastic arm and a second elastic arm with a gap between the first elastic arm and the second elastic arm. side surfaces of both the first elastic arm and second elastic arm facing the static contact terminal are provided with the protrusion, the first elastic arm and the second elastic arm are arranged opposite each other along the axial direction of the needle-shaped structure.

According to some embodiments, the protrusion is strip-shaped.

According to some embodiments, an extending direction of the protrusion is perpendicular to the axial direction of the needle-shaped structure.

According to some embodiments, the auxiliary movable contact piece further includes: a turning section connecting at one end to the movable contact terminal and turning at an angle at the other end relative to the movable contact terminal; and an inclined section connecting at one end to the other end of the turning section, and at the other end to the movable contact lead-out terminal, the inclined section tilts from a plane where the movable contact lead-out terminal is located in a direction away from the auxiliary static contact piece, so that the movable contact lead-out terminal and the auxiliary static contact piece are coplanar.

According to some embodiments, the auxiliary movable contact piece further includes: a widened section disposed between the movable contact lead-out terminal and the inclined section.

The relay in this embodiment includes the aforementioned auxiliary contact assembly.

According to some embodiments, the relay further includes: a base; a contact assembly including a movable contact piece and a static contact piece, wherein the static contact pieces are fixed to the base; and a push rod mechanism movable relative to the base, the movable contact piece is installed on the push rod mechanism, enabling the push rod mechanism to drive the movable contact piece to contact or separate from the static contact piece; wherein the auxiliary movable contact piece of the auxiliary contact assembly connects to the base and is pushed by the push rod mechanism, and the auxiliary static contact piece of the auxiliary contact assembly is fixed to the base.

According to some embodiments, both the auxiliary movable contact piece and the auxiliary static contact piece are inserted into the base, with the movable contact lead-out terminal, the static contact lead-out terminal and the lead-out terminal of the static contact piece extending from the bottom surface of the base.

According to some embodiments, along the movement direction of the push rod mechanism, the auxiliary contact assembly is located at an end of the push rod mechanism away from the movable contact pieces.

According to some embodiments, the end of the push rod mechanism away from the movable contact pieces has a notch for the auxiliary movable contact piece to pass through.

At least one embodiment of the above utility model has the following advantages or beneficial effects: The auxiliary contact assembly of the embodiments of the present disclosure employs a needle-shaped structure for the auxiliary static contact piece, which offers advantages such as simplified component structure, easy forming, and convenient assembly. For example, the auxiliary static contact piece may be formed by cutting round or square wires. Additionally, the side surface of the static contact terminal of the auxiliary static contact piece is used to contact or separate from the movable contact terminal. Due to the relatively large width of the side surface of the static contact terminal, the movable contact terminal and the static contact terminal can achieve contact more easily, preventing misalignment between the movable contact terminal and the static contact terminal from affecting the monitoring of the contact state between the movable contact piece and the static contact piece.

The embodiments of the disclosure are described in detail below with reference to the drawings.

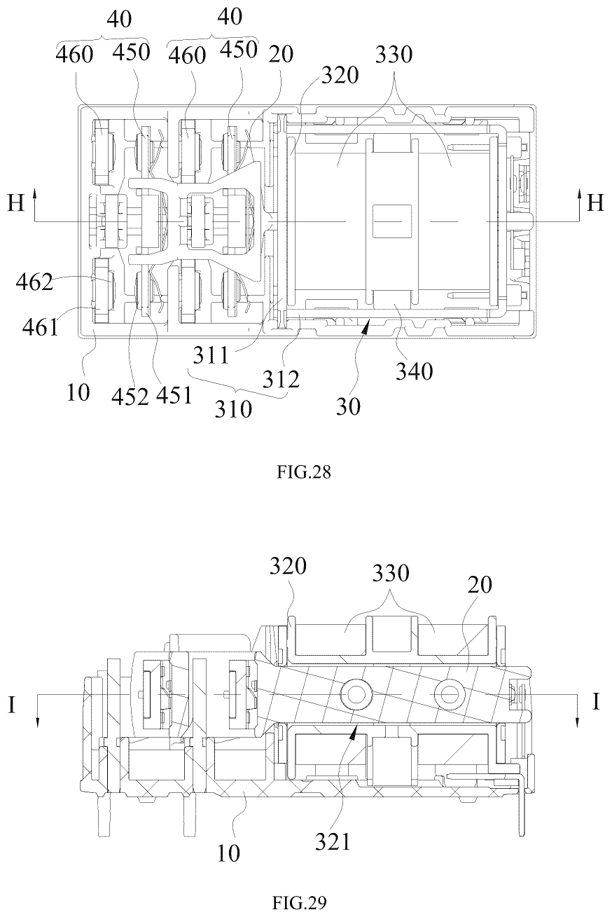

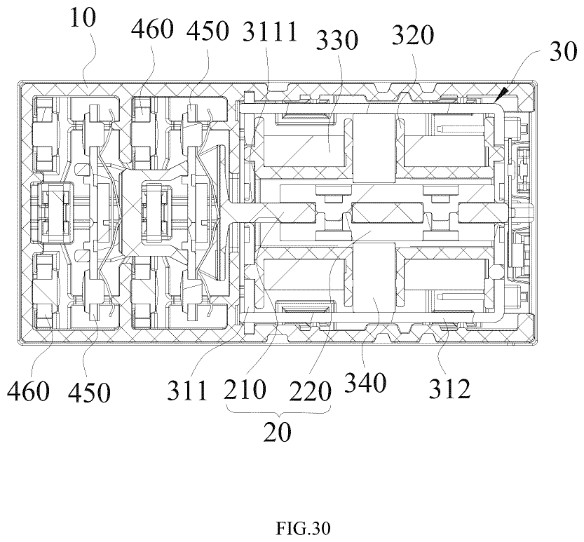

As shown in FIGS. 28 to 30, FIG. 28 shows a top view of the relay according to the embodiment of the present disclosure, with the upper cover omitted. FIG. 29 shows a cross-sectional view taken along line H-H in FIG. 28, and FIG. 30 shows a cross-sectional view taken along line I-I in FIG. 29. The relay of the embodiment of the present disclosure includes a base 10, a push rod mechanism 20, a magnetic circuit mechanism 30, and a contact assembly 40. The push rod mechanism 20, the magnetic circuit mechanism 30, and the contact assembly 40 are arranged on the base 10. The magnetic circuit mechanism 30 controls the contact or separation of the contacts of the contact assembly 40 through the push rod mechanism 20.

The magnetic circuit mechanism 30 includes a yoke structure 310, a bobbin 320, and a coil 330. The yoke structure 310 forms a chamber, and both the bobbin 320 and the coil 330 are arranged in the chamber of the yoke structure 310. The coil 330 is wound around the outer periphery of the bobbin 320 to form a magnetic control circuit. The bobbin 320 is provided with a center hole 321 in the contact-separation direction of the contact assembly 40, and the center hole 321 is used for the push rod mechanism 20 to pass through at one end.

As an example, the yoke structure 310 includes a yoke plate 311 and a U-shaped yoke 312. The yoke plate 311 and the U-shaped yoke 312 are connected to form a ring. The yoke plate 311 is provided with a through hole 3111, and the through hole 3111 is used for the push rod mechanism 20 to pass through.

Of course, in other embodiments, the yoke structure 310 may also include a cylindrical yoke and the yoke plate 311, and the cylindrical yoke and the yoke plate 311 are connected to form a ring.

The magnetic circuit mechanism 30 also includes two permanent magnets 340, which are arranged on the bobbin 320 and located at both sides of the movement direction of the push rod mechanism 20. The two permanent magnets 340 form a magnetic latching circuit structure, which helps reduce power consumption costs, extend service life, and improve stability.

Of course, in other embodiments, the permanent magnet 340 may not be included.

The push rod mechanism 20 is movable relative to the base 10 in the contact-separation direction of the contacts. The push rod mechanism 20 includes a push rod 210 and an iron core 220, and the iron core 220 is connected to the push rod 210. The iron core 220 can move in the contact-separation direction under the action of the magnetic control circuit formed by the coil 330, thereby driving the push rod 210 to move and controlling the contact or separation of the contacts of the contact assembly 40.

Please continue to refer to FIGS. 28 to 30. The contact assembly 40 includes a movable contact piece 450 and a static contact piece 460. The static contact piece 460 is fixedly installed on the base 10, and the movable contact piece 450 is installed on the push rod 210 of the push rod mechanism 20 and moves with the push rod mechanism 20.

In this embodiment, there are two sets of contact assembly 40, and the two sets of contact assembly 40 are arranged along the movement direction of the push rod mechanism 20.

Of course, in other embodiments, the contact assembly 40 may also be one set or other quantities.

The two ends of the movable contact piece 450 in the length direction serve as movable contacts. The movable contacts may protrude from other parts of the movable contact piece 450 or be flush with other parts. The part of the static contact piece 460 in contact with the movable contact piece 450 serves as static contacts. The static contacts may protrude from other parts of the static contact piece 460 or be flush with other parts.

As an example, the movable contact piece 450 includes a movable piece body 451 and a movable contact 452. The movable contact 452 and the movable piece body 451 are separate structures, and the movable contact 452 and the movable piece body 451 may be connected by riveting, but are not limited to this. The static contact piece 460 includes a static piece body 461 and a static contact 462. The static contact 462 and the static piece body 461 are separate structures, and the static contact 462 and the static piece body 461 may be connected by riveting, but are not limited to this.

Of course, in another embodiment, the movable contact 452 and the movable piece body 451 may also be an integrated structure, and the static contact 462 and the static piece body 461 may be an integrated structure.

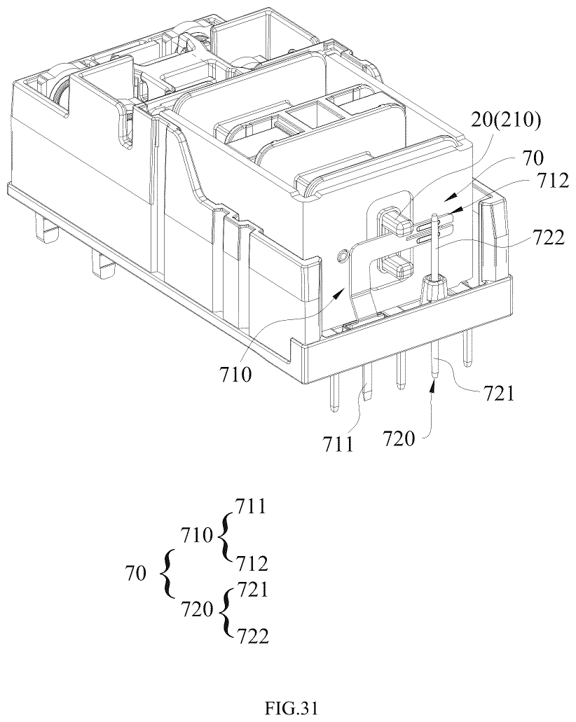

As shown in FIG. 31, FIG. 31 shows a schematic diagram of the auxiliary contact assembly 70 of the relay according to the embodiment of the present disclosure arranged at one end of the push rod mechanism 20. The relay of the embodiment of the present disclosure also includes the auxiliary contact assembly 70. The auxiliary contact assembly 70 includes an auxiliary movable contact piece 710 and an auxiliary static contact piece 720. The auxiliary movable contact piece 710 includes a movable contact terminal 712 and a movable contact lead-out terminal 711. The auxiliary static contact piece 720 includes a static contact terminal 722 and a static contact lead-out terminal 721. The movable contact terminal 712 is used to contact or separate from the static contact terminal 722. The movable contact lead-out terminal 711 and the static contact lead-out terminal 721 can be electrically connected to a monitoring unit. Through the contact or separation of the movable contact terminal 712 and the static contact terminal 722, the circuit formed by the auxiliary movable contact piece 710, the auxiliary static contact piece 720, and the monitoring unit is turned on or off, so that the monitoring unit can monitor the contact state of the movable contact piece 450 and the static contact piece 460 of the contact assembly 40.

The auxiliary movable contact piece 710 of the auxiliary contact assembly 70 is connected to the base 10 and is pushed by the push rod mechanism 20. The auxiliary static contact piece 720 of the auxiliary contact assembly 70 is fixedly connected to the base 10.

During the process of the magnetic circuit mechanism 30 driving the push rod mechanism 20 to move, the push rod mechanism 20 can not only drive the movable contact piece 450 to move but also push the movable contact terminal 712 of the auxiliary movable contact piece 710 to move, causing the movable contact terminal 712 of the auxiliary movable contact piece 710 to contact or separate from the auxiliary static contact piece 720.

In one embodiment, when the movable contact piece 450 contacts the static contact piece 460, the auxiliary movable contact piece 710 separates from the auxiliary static contact piece 720. When the movable contact piece 450 separates from the static contact piece 460, the auxiliary movable contact piece 710 contacts the auxiliary static contact piece 720.

In another embodiment, when the movable contact piece 450 contacts the static contact piece 460, the auxiliary movable contact piece 710 contacts the auxiliary static contact piece 720. When the movable contact piece 450 separates from the static contact piece 460, the auxiliary movable contact piece 710 separates from the auxiliary static contact piece 720.

Please continue to refer to FIG. 31. Both the auxiliary movable contact piece 710 and the auxiliary static contact piece 720 are inserted into the base 10, and both the movable contact lead-out terminal 711 of the auxiliary movable contact piece 710 and the static contact lead-out terminal 721 of the auxiliary static contact piece 720 extend out of the bottom surface of the base 10. The movable contact lead-out terminal 711 and the static contact lead-out terminal 721 extending out of the bottom surface of the base 10 facilitate connection to a circuit board. It should be noted that the bottom surface of the base 10 refers to the surface of the base 10 facing the circuit board when the relay is assembled on the circuit board.

Of course, the lead-out terminal of the static contact piece 460 may also extend out of the bottom surface of the base 10.

Along the movement direction of the push rod mechanism 20, the auxiliary contact assembly 70 is arranged at one end of the push rod mechanism 20 away from the movable contact piece 450.

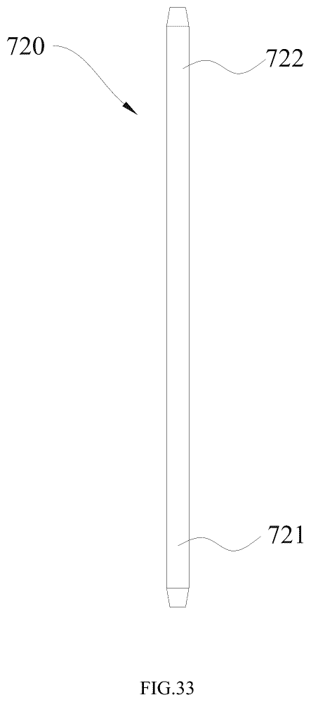

As shown in FIGS. 31 to 33, FIG. 32 shows a schematic diagram of the auxiliary movable contact piece 710 of the embodiment of the present disclosure. FIG. 33 shows a schematic diagram of the auxiliary static contact piece 720 of the embodiment of the present disclosure. The auxiliary static contact piece 720 has a needle-shaped structure and is inserted into the base 10. Along the axial direction of the needle-shaped structure, one end of the needle-shaped structure is the static contact lead-out terminal 721, and the other end is the static contact terminal 722. The side surface of the static contact terminal 722 is used to contact or separate from the movable contact terminal 712.

In this embodiment, the auxiliary static contact piece 720 has a needle-shaped structure, which offers advantages such as simplified component structure, easy forming, and convenient assembly. For example, the auxiliary static contact piece 720 can be formed by cutting round or square wire. Additionally, since the side surface of the static contact terminal 722 has a relatively large width, the movable contact terminal 712 and the static contact terminal 722 can achieve contact more easily, avoiding misalignment that could affect the monitoring of the contact state between the movable contact piece 450 and the static contact piece 460.

It should be understood that the “needle-shaped structure” refers to slender wire or rod materials, where the axial dimension is much larger than the radial dimension.

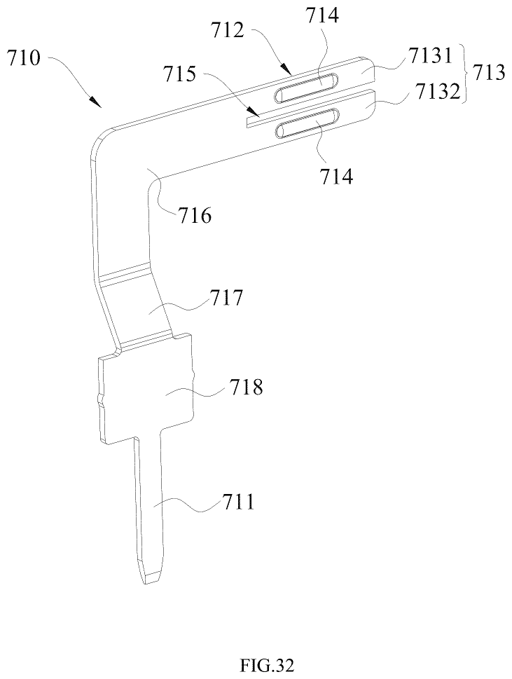

As shown in FIG. 32, the auxiliary movable contact piece 710 of the embodiment of the present disclosure has a sheet-like structure, but is not limited to this. The movable contact terminal 712 includes a base body 713 and a protrusion 714. The base body 713 is connected to the movable contact lead-out terminal 711, and the protrusion 714 protrudes from the surface of the base body 713 facing the static contact terminal 722, serving to contact or separate from the side surface of the static contact terminal 722. Since the protrusion 714 protrudes from the base body 713 and is used to contact the static contact terminal 722, when the movable contact terminal 712 and the static contact terminal 722 are in contact, the side surface of the static contact terminal 722 abuts against the protrusion 714 rather than the surface of the base body 713 facing the static contact terminal 722.

As an example, the protrusion 714 is strip-shaped. The extending direction of the protrusion 714 is perpendicular to the axial direction of the needle-shaped structure. By designing the protrusion 714 as strip-shaped and perpendicular to the axial direction of the needle-shaped structure, the protrusion 714 and the needle-shaped structure are orthogonal in space. This ensures that even if the auxiliary movable contact piece 710 and the auxiliary static contact piece 720 experience slight misalignment when they are in contact, it will not affect the contact between the protrusion 714 and the static contact terminal 722.

Of course, the extending direction of the protrusion 714 does not have to be perpendicular to the axial direction of the needle-shaped structure. For example, it may intersect with the axial direction.

Additionally, the shape of the protrusion 714 is not limited to strip-shaped. For example, it may also be circular, elliptical, etc.

Please continue to refer to FIG. 32. The base body 713 includes a first elastic arm 7131 and a second elastic arm 7132, with a gap 715 between them. Both the first elastic arm 7131 and the second elastic arm 7132 have protrusions 714 on their surfaces facing the static contact terminal 722. The first elastic arm 7131 and the second elastic arm 7132 are arranged opposite each other in the axial direction of the needle-shaped structure. When the movable contact terminal 712 contacts the static contact terminal 722, both protrusions 714 contact the side surface of the static contact terminal 722, improving contact reliability.

The auxiliary movable contact piece 710 also includes a turning section 716, an inclined section 717, and a widened section 718. In the direction from the movable contact terminal 712 to the movable contact lead-out terminal 711, the turning section 716, inclined section 717, and widened section 718 are arranged in sequence. One end of the turning section 716 is connected to the movable contact terminal 712, while the other end is turned at an angle relative to the movable contact terminal 712. One end of the inclined section 717 is connected to the other end of the turning section 716, and the other end is connected to the widened section 718. The other end of the widened section 718 is connected to the movable contact lead-out terminal 711.

In this embodiment, the turning angle of the turning section 716 may be 90 degrees, other angles are also possible. When the angle is 90 degrees, the extending direction of the movable contact terminal 712 is perpendicular to that of the movable contact lead-out terminal 711.

The inclined section 717 tilts from the plane where the movable contact lead-out terminal 711 is located in a direction away from the auxiliary static contact piece 720, so that the movable contact lead-out terminal 711 and the auxiliary static contact piece 720 are coplanar. Due to the inclined section 717, the movable contact lead-out terminal 711 and the movable contact terminal 712 are not coplanar, ensuring that the auxiliary static contact piece 720 can be coplanar with the movable contact lead-out terminal 711 without affecting the contact between the movable contact terminal 712 and the static contact terminal 722. Since the movable contact lead-out terminal 711 and the auxiliary static contact piece 720 are coplanar, and the movable contact terminal 712 tilts inward via the inclined section 717, the auxiliary contact assembly 70 does not occupy excessive space along the movement direction of the push rod mechanism 20, contributing to the miniaturization of the relay.

The width of the widened section 718 is greater than that of the movable contact terminal 712, the turning section 716, the inclined section 717, and the movable contact lead-out terminal 711 of the auxiliary movable contact piece 710. When the auxiliary movable contact piece 710 is inserted into the base 10, the widened section 718 is placed in the insertion hole of the base 10 (as shown in FIG. 31). Due to its larger width, the widened section 718 has a greater surface area, and the auxiliary movable contact piece 710 is connected to the base 10 through the widened section 718, thereby enhancing the connection strength between the auxiliary movable contact piece 710 and the base 10.

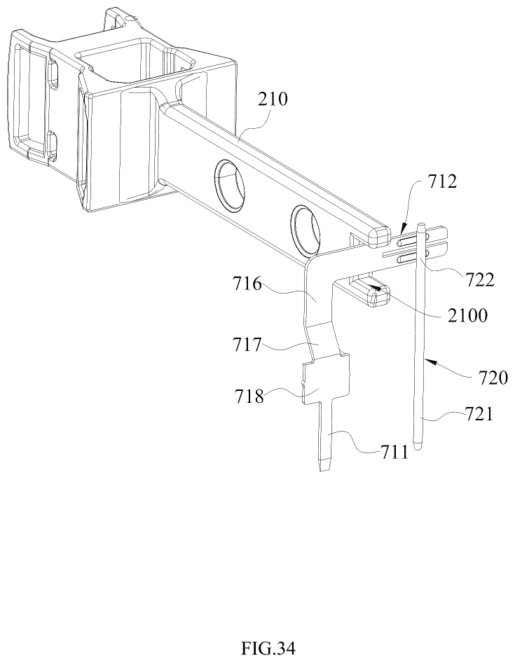

As shown in FIG. 34, which illustrates the assembly of the push rod 210 and the auxiliary contact assembly 70, the auxiliary movable contact piece 710 is connected to the push rod 210 of the push rod mechanism 20. As an example, the auxiliary movable contact piece 710 is connected to the end of the push rod 210 away from the movable contact piece 450.

The end of the push rod 210 away from the movable contact piece 450 has a notch 2100, through which the auxiliary movable contact piece 710 passes. When the push rod 210 moves toward the auxiliary static contact piece 720, the push rod 210 pushes the movable contact terminal 712 of the auxiliary movable contact piece 710 until movable contact terminal 712 contact the static contact terminal 722. When the push rod 210 moves away from the auxiliary static contact piece 720, the auxiliary static contact piece 720 returns to its original position due to its own elastic force, the movable contact terminal 712 separates from the static contact terminal 722. Since the auxiliary movable contact piece 710 passes through the notch 2100, it does not occupy space along the movement direction of the push rod mechanism 20.

It should be understood that the various embodiments/implementations of the present disclosure can be combined without causing contradictions, and examples will not be repeated here.

During the assembly of relays, to ensure that components such as the movable contact piece and static contact piece remain firmly in place after insertion into the base, existing techniques use interference or zero-clearance fits between these components and the base. However, since the base is made of plastic, its positioning strength weakens at high temperatures, affecting the assembly of these components.

To address the issue of weakened positioning strength of plastic at high temperatures, existing solutions involve filling the gaps between components and the base with thermosetting sealant. Specifically, this involves first applying adhesive inside the relay to enhance positioning strength, then sealing the bottom of the relay to prevent water or dust from entering the interior of the relay.

Thus, existing techniques require at least two adhesive dispensing processes, which complicates the assembly process of the relay and results in lower assembly efficiency.

Therefore, the embodiment of the present disclosure provides a relay and a base sealing structure that improve assembly efficiency.

The base sealing structure of the embodiment of the present disclosure is applied to a relay. The base sealing structure includes a base, a metal component, and a sealant. The base has a mounting hole penetrating an inner surface and a bottom surface of the base. The hole wall of the mounting hole has a positioning wall structure and a gap wall structure. The metal component is inserted into the mounting hole, with part of the outer wall surface of the metal component abutting against the positioning wall structure, while a gap exists between another part of the outer wall surface of the metal component and the gap wall structure. The sealant fills the gap.

According to some embodiments of the present disclosure, the positioning wall structure includes a first positioning wall and a second positioning wall, which are arranged opposite each other along a positioning direction.

According to some embodiments of the present disclosure, part of the outer wall surface of the metal component is in interference fit with the first positioning wall and the second positioning wall, respectively.

According to some embodiments of the present disclosure, the positioning wall structure and the gap wall structure are connected by a transition slope.

According to some embodiments of the present disclosure, the metal component includes a static contact piece lead-out terminal, a coil lead-out terminal, or an auxiliary contact lead-out terminal.

According to some embodiments of the present disclosure, the bottom surface of the base is further provided with a sealant groove, which communicates with the mounting hole. The sealant also fills the sealant groove.

According to some embodiments of the present disclosure, part of the outer wall surface of the metal component is in interference fit with the positioning wall structure.

According to some embodiments of the present disclosure, the connection between the hole wall of the mounting hole and the bottom surface of the base has a slope.

According to some embodiments of the present disclosure, one end of the metal component extends out of the bottom surface of the base.

The relay of the embodiment of the present disclosure includes the base sealing structure of the present disclosure.

At least one embodiment of the above disclosure has the following advantages or beneficial effects: The base sealing structure of the embodiment of the present disclosure achieves preliminary positioning through the metal component and the positioning wall structure of the mounting hole, and then fills the gap between the metal component and the gap wall structure with sealant to complete the sealed assembly between the metal component and the base. Compared with the prior art, the present disclosure reduces one adhesive dispensing step, effectively lowers costs, and improves assembly efficiency.

The embodiments of the present disclosure are described in detail below with reference to the accompanying drawings.

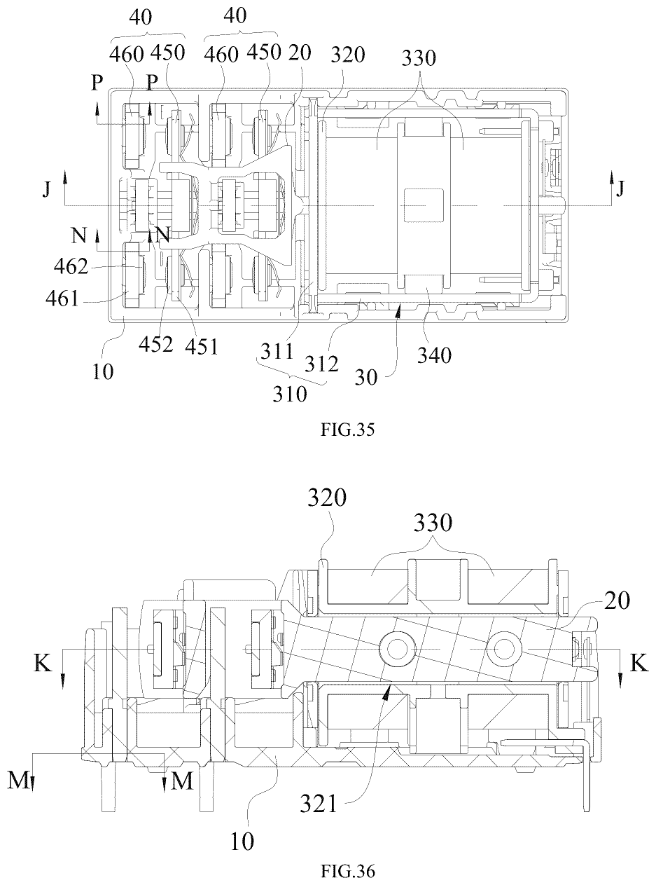

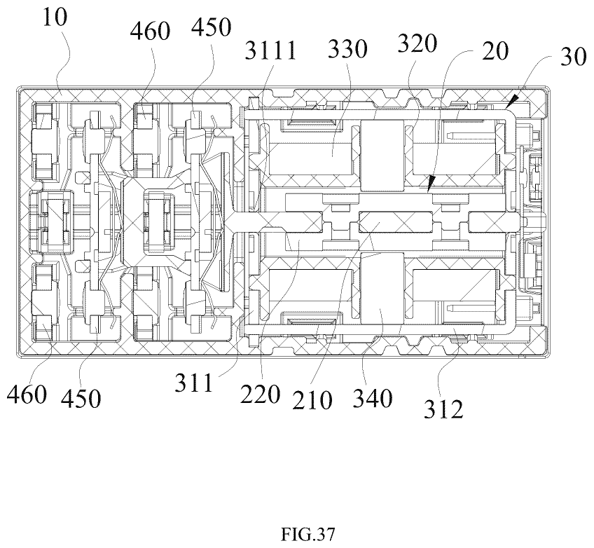

As shown in FIGS. 35 to 37, FIG. 35 shows a top view of the relay according to the embodiment of the present disclosure, with the upper cover omitted. FIG. 36 shows a cross-sectional view taken along line J-J in FIG. 35, and FIG. 37 shows a cross-sectional view taken along line K-K in FIG. 36. The relay of the embodiment of the present disclosure includes a base 10, a push rod mechanism 20, a magnetic circuit mechanism 30, and a contact assembly 40. The push rod mechanism 20, the magnetic circuit mechanism 30, and the contact assembly 40 are arranged on the base 10. The magnetic circuit mechanism 30 controls the contact or separation of the contacts of the contact assembly 40 through the push rod mechanism 20.

The magnetic circuit mechanism 30 includes a yoke structure 310, a bobbin 320, and a coil 330. The yoke structure 310 forms a chamber, and both the bobbin 320 and the coil 330 are arranged in the chamber of the yoke structure 310. The coil 330 is wound around the outer periphery of the bobbin 320 to form a magnetic control circuit. The bobbin 320 is provided with a center hole 321 in the contact-separation direction of the contact assembly 40, and the center hole 321 is used for the push rod mechanism 20 to pass through at one end.

As an example, the yoke structure 310 includes a yoke plate 311 and a U-shaped yoke 312. The yoke plate 311 and the U-shaped yoke 312 are connected to form a ring. The yoke plate 311 is provided with a through hole 3111, which is used for the push rod mechanism 20 to pass through.

Of course, in other embodiments, the yoke structure 310 may also include a cylindrical yoke and the yoke plate 311, and the cylindrical yoke and the yoke plate 311 are connected to form a ring.

The magnetic circuit mechanism 30 also includes two permanent magnets 340, which are arranged on the bobbin 320 and located at both sides of the movement direction of the push rod mechanism 20. The two permanent magnets 340 form a magnetic latching circuit structure, which helps reduce power consumption costs, extend service life, and improve stability.

Of course, in other embodiments, the permanent magnet 340 may not be included.

Please continue to refer to FIGS. 35 to 37. The contact assembly 40 includes a movable contact piece 450 and a static contact piece 460. The static contact piece 460 is fixedly installed on the base 10, and the movable contact piece 450 is installed on the push rod mechanism 20 and moves with the push rod mechanism 20.

In this embodiment, there are two sets of contact assembly 40, arranged along the movement direction of the push rod mechanism 20.

Of course, in other embodiments, the contact assembly 40 may also be one set or other quantities.

The two ends of the movable contact piece 450 in the length direction serve as movable contacts. The movable contacts may protrude from other parts of the movable contact piece 450 or be flush with other parts. The part of the static contact piece 460 in contact with the movable contact piece 450 serves as static contacts. The static contacts may protrude from other parts of the static contact piece 460 or be flush with other parts.

As an example, the movable contact piece 450 includes a movable piece body 451 and a movable contact 452. The movable contact 452 and the movable piece body 451 are separate structures, and the movable contact 452 and the movable piece body 451 may be connected by riveting, but are not limited to this. The static contact piece 460 includes a static piece body 461 and a static contact 462. The static contact 462 and the static piece body 461 are separate structures, and the static contact 462 and the static piece body 461 may be connected by riveting, but are not limited to this.

Of course, in another embodiment, the movable contact 452 and the movable piece body 451 may also be an integrated structure, and the static contact 462 and the static piece body 461 may be an integrated structure.

As shown in FIG. 37, the push rod mechanism 20 includes a push rod 210 and an iron core 220, and the iron core 220 is connected to the push rod 210. The iron core 220 can move in the contact-separation direction under the action of the magnetic control circuit formed by the coil 330, thereby driving the push rod 210 to move and controlling the contact or separation of the contacts of the contact assembly 40.

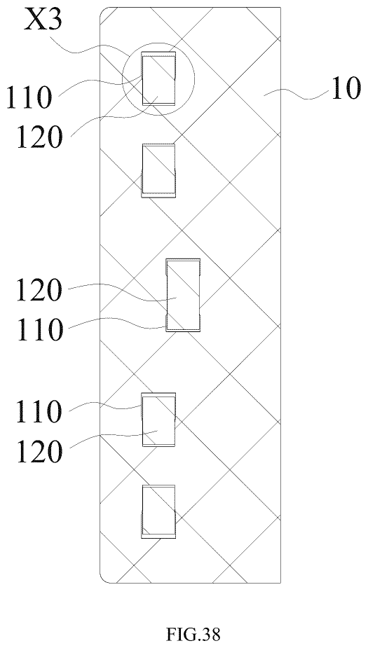

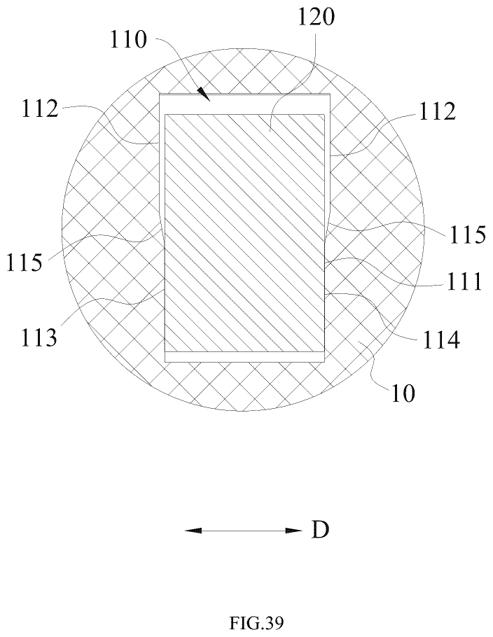

As shown in FIGS. 38 and 39, FIG. 38 shows a cross-sectional view taken along line M-M in FIG. 36. FIG. 39 shows a partial enlarged view of area X3 in FIG. 38. The relay of the embodiment of the present disclosure also includes a base sealing structure. The base sealing structure includes the base 10, a metal component 120, and a sealant (omitted in the FIG.). The base 10 has a mounting hole 110 penetrating its inner surface and bottom surface. The hole wall of the mounting hole 110 has a positioning wall structure 111 and a gap wall structure 112. The metal component 120 is inserted into the mounting hole 110, with part of its outer wall surface abutting against the positioning wall structure 111, while a gap exists between another part of its outer wall surface and the gap wall structure 112. The sealant fills the gap.

In the base sealing structure of the embodiment of the present disclosure, the hole wall of the mounting hole 110 of the base 10 has a positioning wall structure 111 and a gap wall structure 112. When the metal component 120 is assembled with the base 10, the metal component 120 is inserted into the mounting hole 110. On one hand, part of the outer wall surface of the metal component 120 abuts against the positioning wall structure 111, achieving preliminary positioning of the metal component 120. On the other hand, a gap exists between another part of the outer wall surface of the metal component 120 and the gap wall structure 112. Utilizing the siphon effect, the sealant can climb from the bottom surface side of the base 10 along the gap to the inner surface of the base 10 until reaching the opening of the mounting hole 110, filling the gap and further enhancing the sealing and positioning strength between the metal component 120 and the base 10. At the same time, the heat resistance of the sealant is stronger than that of plastic materials, improving the welding heat resistance of the relay product.

Thus, in the base sealing structure of the embodiment of the present disclosure, preliminary positioning is first achieved through the metal component 120 and the positioning wall structure 111 of the mounting hole 110, and then the gap between the metal component 120 and the gap wall structure 112 of the mounting hole 110 is filled with sealant to complete the sealed assembly between the metal component 120 and the base 10. Compared with the prior art, the present disclosure reduces one adhesive dispensing step, effectively lowers costs, and improves assembly efficiency.

It should be understood that the metal component 120 can be any component in the relay that needs to be assembled with the mounting hole 110 of the base 10, including but not limited to a static contact piece lead-out terminal, a coil lead-out terminal, or an auxiliary contact lead-out terminal.

As an example, one end of the metal component 120 extends out of the bottom surface of the base 10 through the mounting hole 110. Of course, in other embodiments, one end of the metal component 120 may not extend out of the bottom surface of the base 10.

As shown in FIG. 39, the positioning wall structure 111 includes a first positioning wall 113 and a second positioning wall 114, which are arranged opposite each other along a positioning direction D. By abutting the first positioning wall 113 and the second positioning wall 114 against the metal component 120, the degree of freedom of the metal component 120 relative to the base 10 in the positioning direction D is restricted.

Here, the positioning direction D may be the length direction of the relay.

It should be understood that the shapes of the first positioning wall 113 and the second positioning wall 114 are adapted to the outer contour shape of the metal component 120. For example, when the cross-sectional shape of the metal component 120 is rectangular, the first positioning wall 113 and the second positioning wall 114 may be flat surfaces. Of course, in other embodiments, when the cross-sectional shape of the metal component 120 is circular, the shapes of the first positioning wall 113 and the second positioning wall 114 may be curved surfaces.

Part of the outer wall surface of the metal component 120 is in interference fit with the positioning wall structure 111. In the embodiment of the present disclosure, part of the outer wall surface of the metal component 120 is in interference fit with the first positioning wall 113 and the second positioning wall 114, respectively. Of course, in other embodiments, part of the outer wall surface of the metal component 120 and the positioning wall structure 111 may also adopt a zero-clearance fit.

The positioning wall structure 111 and the gap wall structure 112 are connected by a transition slope 115.

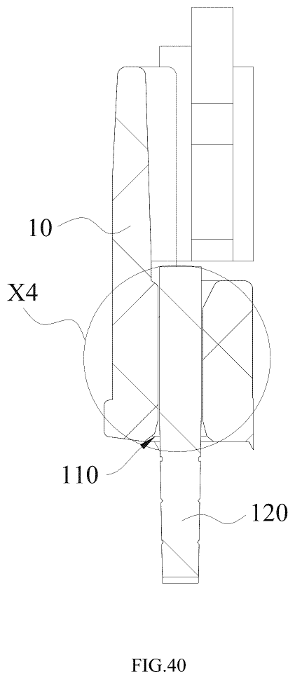

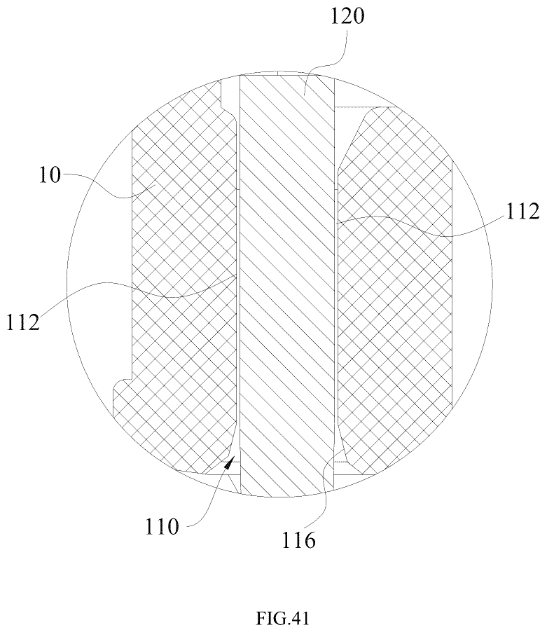

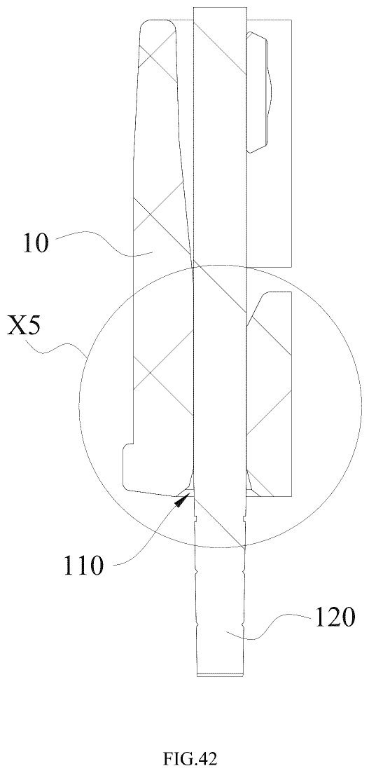

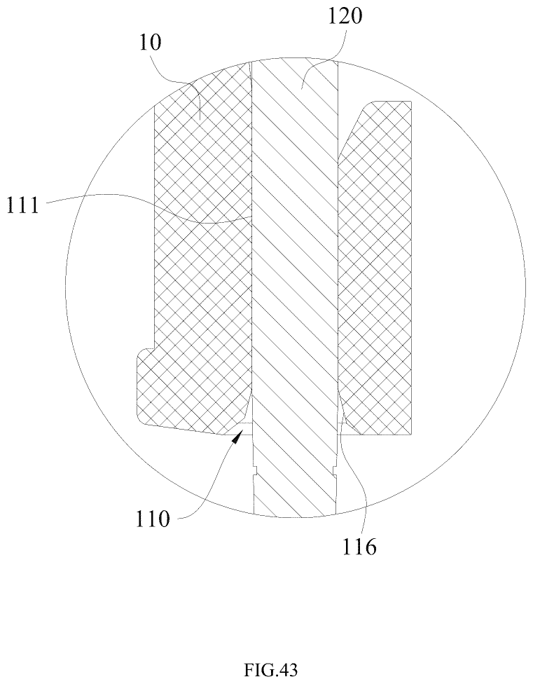

As shown in FIGS. 40 to 43, FIG. 40 shows a cross-sectional view taken along line N-N in FIG. 35. FIG. 41 shows a partial enlarged view of area X4 in FIG. 40. FIG. 42 shows a cross-sectional view taken along line P-P in FIG. 35. FIG. 43 shows a partial enlarged view of area X5 in FIG. 42. FIG. 40 is a cross-sectional view taken along the position corresponding to the positioning wall structure 111 of the metal component 120 and the mounting hole 110, and FIG. 42 is a cross-sectional view taken along the position corresponding to the gap wall structure 112 of the metal component 120 and the mounting hole 110.

The connection between the hole wall of the mounting hole 110 and the bottom surface of the base 10 has a slope 116. The slope 116 increases the depth of sealant flow.

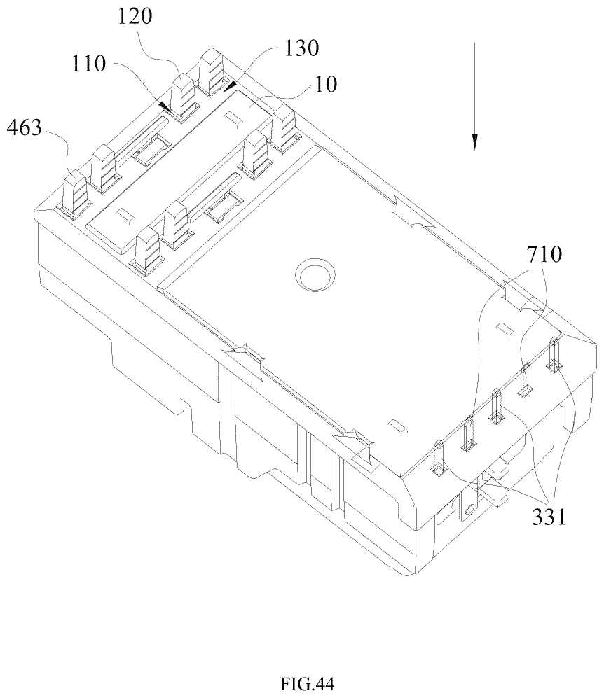

As shown in FIG. 44, FIG. 44 shows a three-dimensional schematic diagram of the relay according to the embodiment of the present disclosure, with the bottom surface of the base 10 facing upward. The bottom surface of the base 10 is further provided with a sealant groove 130, which communicates with the mounting hole 110. The sealant also fills the sealant groove 130 to expand the coverage of the sealant. The bottom of the sealant groove 130 is connected to the hole wall of the mounting hole 110 through the slope 116.

Of course, in other embodiments, the sealant groove 130 and the slope 116 may be the same slope.

The adhesive dispensing process of the relay of the embodiment of the present disclosure is described in detail below with reference to FIG. 44: As described in the background, relays in the prior art require two adhesive dispensing processes: first, applying adhesive between components and the base in the direction indicated by the arrow in FIG. 1, and then performing a second adhesive dispensing in the direction indicated by the arrow in FIG. 2. This requires at least two adhesive dispensing processes in different directions.

In contrast, the relay of the embodiment of the present disclosure achieves preliminary positioning of the metal component 120 by abutting against part of its outer wall surface against the positioning wall structure 111 (no adhesive dispensing is required during preliminary positioning). Subsequently, adhesive is applied from one side of the bottom surface of the base 10 (in the direction indicated by the arrow in FIG. 44) into the gap between the metal component 120 and the gap wall structure 112. At the same time, adhesive can also be applied to the gap between the upper cover and the base 10 in the same direction. Thus, in the embodiment of the present disclosure, adhesive can be applied in a single dispensing direction (the arrow direction in FIG. 44) to the gaps between the static contact piece lead-out terminal 463 and the base 10, the coil lead-out terminal 331 and the base 10, the auxiliary contact lead-out terminal 710 and the base 10, and the upper cover and the base 10, significantly improving adhesive dispensing efficiency.

It should be understood that the various embodiments/implementations of the present disclosure can be combined without causing contradictions, and examples will not be repeated here.

It should be understood that the present disclosure is not limited to the detailed structure and arrangement of components described in this specification. The present disclosure can have other embodiments and can be realized and executed in various ways. The foregoing variations and modifications fall within the scope of the present disclosure. It should be understood that the disclosure and definition of the present disclosure extend to all alternative combinations of two or more individual features mentioned or implied in the text and/or drawings. All these different combinations constitute multiple alternative aspects of the present disclosure. The embodiments described in this specification illustrate the best-known mode for implementing the present disclosure and will enable those skilled in the art to utilize the present disclosure.

1-24. (canceled)

25. An auxiliary contact assembly, applied to relays, comprising:
an auxiliary movable contact piece comprises a movable contact terminal; and
an auxiliary static contact piece having a needle-shaped structure, along an axial direction of the needle-shaped structure, the auxiliary static contact piece comprises a static contact lead-out terminal and a static contact terminal, wherein a side surface of the static contact terminal is configured to contact or separate from the movable contact terminal.

26. The auxiliary contact assembly according to claim 25, the auxiliary movable contact piece further comprises a movable contact lead-out terminal.

27. The auxiliary contact assembly according to claim 25, the movable contact terminal comprises:
a base body; and
a protrusion protruding from the surface of the base body facing the static contact terminal, for contacting or separating from the side surface of the static contact terminal.

28. The auxiliary contact assembly according to claim 27, the base body comprises a first elastic arm and a second elastic arm with a gap between the first elastic arm and the second elastic arm. side surfaces of both the first elastic arm and second elastic arm facing the static contact terminal are provided with the protrusion, the first elastic arm and the second elastic arm are arranged opposite each other along the axial direction of the needle-shaped structure.

29. The auxiliary contact assembly according to claim 27, the protrusion is strip-shaped.

30. The auxiliary contact assembly according to claim 29, an extending direction of the protrusion is perpendicular to the axial direction of the needle-shaped structure.

31. The auxiliary contact assembly according to claim 26, the auxiliary movable contact piece further comprises:
a turning section connecting at one end to the movable contact terminal and turning at an angle at the other end relative to the movable contact terminal; and
an inclined section connecting at one end to the other end of the turning section, and at the other end to the movable contact lead-out terminal, the inclined section tilts from a plane where the movable contact lead-out terminal is located in a direction away from the auxiliary static contact piece, so that the movable contact lead-out terminal and the auxiliary static contact piece are coplanar.

32. The auxiliary contact assembly according to claim 31 the auxiliary movable contact piece further comprises:
a widened section disposed between the movable contact lead-out terminal and the inclined section.

33. A relay comprising an auxiliary contact assembly, wherein the auxiliary contact assembly comprises:
an auxiliary movable contact piece comprises a movable contact terminal; and
an auxiliary static contact piece having a needle-shaped structure, along an axial direction of the needle-shaped structure, the auxiliary static contact piece comprises a static contact lead-out terminal and a static contact terminal, wherein a side surface of the static contact terminal is configured to contact or separate from the movable contact terminal.

34. The relay according to claim 33, the auxiliary movable contact piece further comprises a movable contact lead-out terminal.

35. The relay according to claim 33 the movable contact terminal comprises:
a base body; and
a protrusion protruding from the surface of the base body facing the static contact terminal, for contacting or separating from the side surface of the static contact terminal.

36. The relay according to claim 35, the base body comprises a first elastic arm and a second elastic arm with a gap between the first elastic arm and the second elastic arm. side surfaces of both the first elastic arm and second elastic arm facing the static contact terminal are provided with the protrusion, the first elastic arm and the second elastic arm are arranged opposite each other along the axial direction of the needle-shaped structure.

37. The relay according to claim 35, the protrusion is strip-shaped.

38. The relay according to claim 37, an extending direction of the protrusion is perpendicular to the axial direction of the needle-shaped structure.

39. The relay according to claim 34, the auxiliary movable contact piece further comprises:
a turning section connecting at one end to the movable contact terminal and turning at an angle at the other end relative to the movable contact terminal; and
an inclined section connecting at one end to the other end of the turning section, and at the other end to the movable contact lead-out terminal, the inclined section tilts from a plane where the movable contact lead-out terminal is located in a direction away from the auxiliary static contact piece, so that the movable contact lead-out terminal and the auxiliary static contact piece are coplanar.

40. The relay according to claim 39, the auxiliary movable contact piece further comprises:
a widened section disposed between the movable contact lead-out terminal and the inclined section.

41. The relay according to claim 33, further comprising:
a base;
a contact assembly comprising a movable contact piece and a static contact piece, wherein the static contact pieces are fixed to the base; and
a push rod mechanism movable relative to the base, the movable contact piece is installed on the push rod mechanism, enabling the push rod mechanism to drive the movable contact piece to contact or separate from the static contact piece;
wherein the auxiliary movable contact piece of the auxiliary contact assembly connects to the base and is pushed by the push rod mechanism, and the auxiliary static contact piece of the auxiliary contact assembly is fixed to the base.

42. The relay according to claim 34, both the auxiliary movable contact piece and the auxiliary static contact piece are inserted into the base, with the movable contact lead-out terminal, the static contact lead-out terminal and the lead-out terminal of the static contact piece extending from the bottom surface of the base.

43. The relay according to claim 33, along the movement direction of the push rod mechanism, the auxiliary contact assembly is located at an end of the push rod mechanism away from the movable contact pieces.

44. The relay according to claim 33, the end of the push rod mechanism away from the movable contact pieces has a notch for the auxiliary movable contact piece to pass through.
